(19) United States
(12) Patent Application Publication
(10) Pub. No.: US 2026/0169604 A1
(43) Pub. Date: Jun. 18, 2026

(54) SYSTEMS AND METHODS FOR AUGMENTED VISUALIZATION USING ACTIVITY WINDOWS

(71) Applicant: Pramana, Inc., Cambridge, MA (US)

(72) Inventors: Prasanth Perugupalli, Cary, NC (US); Prateek Jain, Karnataka (IN); Christopher Goel, Cambridge, MA (US); Bharathwaj Raghunathan, Oakville (CA)

(73) Assignee: Pramana, Inc., Cambridge, MA (US)

(21) Appl. No.: 19/529,759

(22) Filed: Feb. 4, 2026

Related U.S. Application Data
(63) Continuation-in-part of application No. 18/660,007, filed on May 9, 2024, now Pat. No. 12,573,194.

(51) Int. Cl. G06F 3/0481

(52) U.S. Cl. CPC G06F 3/0481; G06F 2203/04803

(57) ABSTRACT

A system for augmented visualization using activity windows includes a processor and a memory containing instructions that configure the processor. The processor is configured to receive image data, generate a display data structure with an activity window, and instantiate artificial intelligence (AI) agents within the activity window. The system receives user input associated with the image data and executes the AI agents to retrieve external data and generate agent outputs based on the external data and image data. The display data structure is updated by modifying the activity window as a function of the agent outputs.

### CROSS-REFERENCE TO RELATED APPLICATIONS

This application is a continuation-in-part of U.S. Non-provisional patent application Ser. No. 18/660,007, filed on May 9, 2024, and entitled “SYSTEMS AND METHODS FOR AUGMENTED VISUALIZATION USING ACTIVITY WINDOWS,” the entirety of which is incorporated herein by reference.

### FIELD OF THE INVENTION

The present invention generally relates to the field of image processing. In particular, the present invention is directed to systems and methods for augmented visualization using activity windows.

### BACKGROUND

Visualizing images at multiple resolutions with overlapping overlays may occlude image content. This may make the visualization process particularly difficult and cause certain content to be missed. For example, viewing biological slide images can be a challenging process. A user may be overwhelmed by the information presented on the user interface (UI) when overlays or other features are present. A UI solution is needed that allows a user to view all of the information generated by image processing algorithms without overwhelming the user or causing occlusion of certain image content.

### SUMMARY OF THE DISCLOSURE

In some aspects, the techniques described herein relate to a system for augmented visualization using activity windows. The system includes at least a processor, and a memory communicatively connected to the at least a processor, wherein the memory contains instructions configuring the at least a processor to receive image data, generate a display data structure including at least an activity window configured to display derived content associated with the image data, instantiate, within the at least an activity window, one or more artificial intelligence (AI) agents, receive, in response to user interaction with the display data structure, a user input associated with the image data, execute the one or more AI agents, wherein executing the one or more AI agents includes retrieving, using the one or more AI agents, external data from one or more external data sources as a function of the user input, and generating, using the one or more AI agents, one or more agent outputs as a function of the external data and the image data, and update the display data structure, wherein updating the display data structure includes updating the at least an activity window as a function of the one or more agent outputs.

In some aspects, the techniques described herein relate to a method of augmented visualization using activity windows. The method includes receiving, using at least a processor, image data, generating, using the at least a processor, a display data structure including at least an activity window configured to display derived content associated with the image data, instantiating, using the at least a processor, one or more artificial intelligence (AI) agents within the at least an activity window, receiving, using the at least a processor, a user input associated with the image data in response to user interaction with the display data structure, executing, using the at least a processor, the one or more AI agents, wherein executing the one or more AI agents includes retrieving, using the one or more AI agents, external data from one or more external data sources as a function of the user input, and generating, using the one or more AI agents, one or more agent outputs as a function of the external data and the image data, and updating, using the at least a processor, the display data structure, wherein updating the display data structure includes updating the at least an activity window as a function of the one or more agent outputs.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1A illustrates a block diagram of an exemplary embodiment of a system for augmented visualization using activity windows;

FIG. 1B illustrates a block diagram of another exemplary embodiment of a system for augmented visualization using activity windows;

FIG. 2 illustrates a particular implementation of a system for augmented visualization using activity windows, wherein a user may highlight a portion of the image data;

FIG. 3 illustrates a particular implementation of a system for augmented visualization using activity windows, wherein a user may select a segment of image data to view;

FIG. 4 illustrates a particular implementation of a system for augmented visualization using activity windows, wherein selected segments from the activity window are shown;

FIG. 5 illustrates a particular implementation of a system for augmented visualization using activity windows, wherein selected segments from multiple activity windows are shown;

FIG. 6 illustrates an exemplary machine-learning module;

FIG. 7 illustrates an exemplary neural network;

FIG. 8 illustrates an exemplary node of a neural network;

FIG. 9 illustrates an exemplary user interface with a display data structure;

FIG. 10A illustrates a flow diagram of an exemplary method for image processing and labeling for user display;

FIG. 10B illustrates a flow diagram of another exemplary method for image processing and labeling for user display; and

FIG. 11 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to a system for and method of augmented visualization using activity windows. The system includes at least a processor, and a memory communicatively connected to the at least a processor, wherein the memory contains instructions configuring the at least a processor to receive image data, generate a display data structure including at least an activity window configured to display derived content associated with the image data, instantiate, within the at least an activity window, one or more artificial intelligence (AI) agents, receive, in response to user interaction with the display data structure, a user input associated with the image data, execute the one or more AI agents, wherein executing the one or more AI agents includes retrieving, using the one or more AI agents, external data from one or more external data sources as a function of the user input, and generating, using the one or more AI agents, one or more agent outputs as a function of the external data and the image data, and update the display data structure, wherein updating the display data structure includes updating the at least an activity window as a function of the one or more agent outputs.

Aspects of the present disclosure are also directed to systems and methods for image processing and labeling for user display. In an embodiment, systems for augmented visualization using activity windows may include at least a processor, a memory communicatively connected to the at least a processor and an interactive display device. The memory may store instructions configuring the processor to initiate a method for image processing and labeling for user display. A method for augmented visualization using activity windows may include receiving image data from an imaging device, executing at least a first algorithm on the image data, wherein the first algorithm is configured to output annotation data associated with the image data, generating a display data structure, and displaying, at interactive display device, the display data structure.

Aspects of the present disclosure can be used to process and label images for user display. Aspects of the present disclosure can also be used to unclutter a user's viewing experience. This is so, at least in part, because the display data structure includes at least a primary window and an activity window. This allows a user to view image data with or without annotations or other overlays intended to aid a viewer.

Aspects of the present disclosure allow for augmented visualization using activity windows.

In some embodiments, some embodiments, the processor may improve a technical functioning of the system by dynamically managing how image data, derived content, and agent outputs are rendered within the display data structure. In some cases, conventional systems display all analytical overlays directly on top of image data, which may result in visual clutter, occlusion of salient features, and reduced interpretability of the underlying image. By contrast, the processor of the present disclosure may separate raw image visualization from analytical and AI-generated content through coordinated use of at least a primary window and at least an activity window. This architectural separation may enable the processor to selectively present, suppress, or relocate overlays and annotations without modifying the underlying image data, thereby improving rendering efficiency and preserving image fidelity.

In some embodiments, the processor may further provide a technical solution to the problem of synchronizing user interaction with multi-stage image analysis. In some cases, user input such as zooming, panning, or selecting a region of interest may require recalculation of annotations, re-alignment of overlays, or re-execution of AI agents. The processor may address this problem by updating the display data structure as a function of both user interaction and agent outputs, such that changes to a presentation state are propagated deterministically across the primary window and the activity window. This coordinated update mechanism may reduce latency, prevent inconsistent visual states, and ensure that analytical content remains spatially and semantically aligned with the corresponding image data.

In some embodiments, the processor may also improve computational efficiency by controlling execution flow among multiple AI agents based on contextual needs. For example, deterministic agents may first evaluate user input or image characteristics to determine whether further probabilistic analysis or natural language generation is required. In some cases, this may prevent unnecessary invocation of computationally expensive models when a rule-based determination is sufficient. By selectively triggering, suppressing, or parameterizing downstream AI agents, the processor may reduce processing overhead, conserve system resources, and improve responsiveness of the user interface, thereby addressing technical challenges associated with scaling AI-assisted visualization systems.

In some embodiments, the processor may further enhance system robustness by providing a repeatable and traceable analytical pipeline. By separating deterministic decision-making from generative reasoning and explicitly managing how outputs are integrated into the display data structure, the system may reduce ambiguity in how conclusions are derived and presented. This may be particularly advantageous in technical domains involving image-based analysis, where reproducibility, interpretability, and controlled visualization are critical. Accordingly, the processor-centric architecture described herein may provide a technical solution that improves reliability, clarity, and performance of augmented visualization systems while maintaining flexibility for advanced AI-driven analysis.

Exemplary embodiments illustrating aspects of the present disclosure are described below in the context of several specific examples.

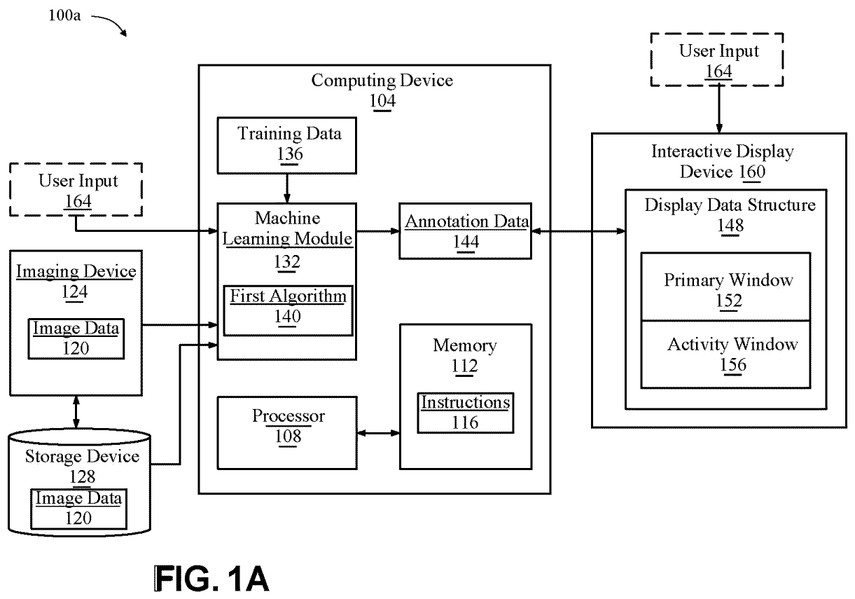

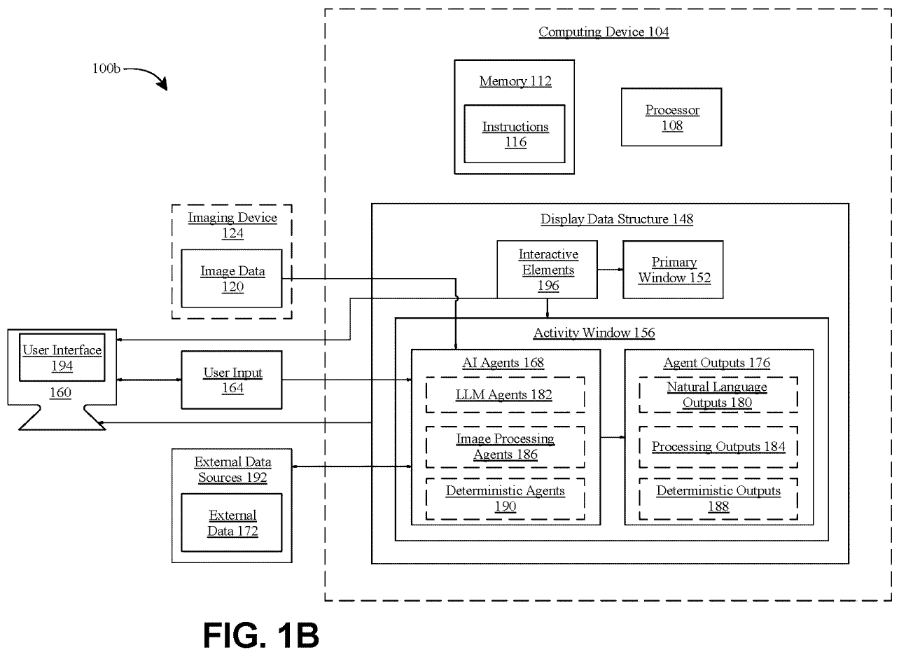

Referring now to FIG. 1A, an exemplary embodiment of a system 100a for augmented visualization using activity windows is illustrated. Systems for augmented visualization using activity windows may include at least a processor 108, a memory 112 communicatively connected to the at least a processor 108 and an interactive display device 160. Memory 112 may store instructions 116 configuring processor 108 to receive image data 120 from imaging device 124, execute at least a first algorithm 140 on image data 120, and generate display data structure 148. Interactive display device 160 may be configured to display an embodiment of display data structure 148 in accordance with user input 164.

With further reference to FIG. 1A, system 100a may be configured to receive image data 120 from imaging device 124. Image data 120 may include one or more image files. For example, and without limitation image data 120 may include one or more raster image files and/or one or more vector image files. This may further include image extensions such as Joint Photographic Experts Group (JPEG), Portable Network Graphics (PNG), Graphics Interchange Format (GIF), Tagged Image File (TIFF), Photoshop Document (PSD), Portable Document Format (PDF), Encapsulated Postscript (EPS), Adobe Illustrator Document (AI), Adobe InDesign Document (INDD), and/or Raw Image Formats (RAW). As a nonlimiting example, image data 120 may include one or more scans of one or more tissue slides. As used throughout this disclosure, “tissue slides,” refers to a slide that exhibits a biological specimen for viewing. A tissue slide may include a plurality of different cell types, a single cell type, and/or the like. Image data 120 may be received from imaging device 124 directly and/or from storage device 128 where image data 120 may be stored. Imaging device 124 may additionally be communicatively connected to storage device 128. Imaging device 124 is any device that is designed and/or configured to capture a digitized visual of a real-life element. Imaging device 124 may include an optical scanner, x-rays, computed tomography (CT) scanners, ultrasonography, mammography, positron-emission tomography (PET), and/or the like. In some embodiments, imaging device 124 may include a table on which a tissue slide may be mounted. Further, in some embodiments the table may be moveable in the X, Y, Z directions.

Continuing to reference FIG. 1A, in some embodiments, imaging device 124 additionally include at least a camera. As used in this disclosure, a “camera” is a device that is configured to sense electromagnetic radiation, such as without limitation visible light, and generate an image representing the electromagnetic radiation. In some cases, a camera may include one or more optics. Exemplary non-limiting optics include spherical lenses, aspherical lenses, reflectors, polarizers, filters, windows, aperture stops, and the like. In some cases, at least a camera may include an image sensor. Exemplary non-limiting image sensors include digital image sensors, such as without limitation charge-coupled device (CCD) sensors and complimentary metal-oxide-semiconductor (CMOS) sensors, chemical image sensors, and analog image sensors, such as without limitation film. In some cases, a camera may be sensitive within a non-visible range of electromagnetic radiation, such as without limitation infrared. As used in this disclosure, “image data” is information representing at least a physical scene, space, and/or object. In some cases, image data 120 may be generated by a camera. “Image data” may be used interchangeably through this disclosure with “image,” where image is used as a noun. An image may be optical, such as without limitation where at least an optic is used to generate an image of an object. An image may be material, such as without limitation when film is used to capture an image. An image may be digital, such as without limitation when represented as a bitmap. Alternatively, an image may be comprised of any media capable of representing a physical scene, space, and/or object.

Still referring to FIG. 1A, in some embodiments, system 100a may include a machine vision system that includes at least a camera. A machine vision system may use images from at least a camera, to make a determination about a scene, space, and/or object. For example, in some cases a machine vision system may be used for world modeling or registration of objects within a space. In some cases, registration may include image processing, such as without limitation object recognition, feature detection, edge/corner detection, and/or the like. Non-limiting example of feature detection may include scale invariant feature transform (SIFT), Canny edge detection, Shi Tomasi corner detection, and/or the like. In some cases, registration may include one or more transformations to orient a camera frame (or an image or video stream) relative a three-dimensional coordinate system; exemplary transformations include without limitation homography transforms and affine transforms. In an embodiment, registration of first frame to a coordinate system may be verified and/or corrected using object identification and/or computer vision, as described above. For instance, and without limitation, an initial registration to two dimensions, represented for instance as registration to the x and y coordinates, may be performed using a two-dimensional projection of points in three dimensions onto a first frame, however. A third dimension of registration, representing depth and/or a z axis, may be detected by comparison of two frames; for instance, where first frame includes a pair of frames captured using a pair of cameras (e.g., stereoscopic camera also referred to in this disclosure as stereo-camera), image recognition and/or edge detection software may be used to detect a pair of stereoscopic views of images of an object; two stereoscopic views may be compared to derive z-axis values of points on object permitting, for instance, derivation of further z-axis points within and/or around the object using interpolation. This may be repeated with multiple objects in field of view, including without limitation environmental features of interest identified by object classifier and/or indicated by an operator. In an embodiment, x and y axes may be chosen to span a plane common to two cameras used for stereoscopic image capturing and/or an xy plane of a first frame; a result, x and y translational components and φ may be pre-populated in translational and rotational matrices, for affine transformation of coordinates of object, also as described above. Initial x and y coordinates and/or guesses at transformational matrices may alternatively or additionally be performed between first frame and second frame, as described above. For each point of a plurality of points on object and/or edge and/or edges of object as described above, x and y coordinates of a first stereoscopic frame may be populated, with an initial estimate of z coordinates based, for instance, on assumptions about object, such as an assumption that ground is substantially parallel to an xy plane as selected above. Z coordinates, and/or x, y, and z coordinates, registered using image capturing and/or object identification processes as described above may then be compared to coordinates predicted using initial guess at transformation matrices; an error function may be computed using by comparing the two sets of points, and new x, y, and/or z coordinates, may be iteratively estimated and compared until the error function drops below a threshold level. In some cases, a machine vision system may use a classifier, such as any classifier described throughout this disclosure. The process of digitizing one or more captured image data 120 may be accomplished, without limitation, as disclosed in U.S. application Ser. No. 18/428,823, filed on Jan. 31, 2024 and entitled “SYSTEMS AND METHODS FOR VISUALIZATION OF DIGITIZED SLIDES” the entirety of which is incorporated herein by reference.

With continued reference to FIG. 1A, system 100a may be configured to execute at least a first algorithm 140 on image data 120. In an embodiment, machine learning module 132 may be configured to execute one or more of the algorithms discussed below. Training of machine learning module 132 may take place at computing device 104 and/or remotely. Exemplary training data 136 may vary depending on the algorithm. Retraining of machine learning module 132 may take place at computing device 104 and/or remotely. Additionally, outputs of machine learning module 132 may reiteratively be used as new training data 136. At least a first algorithm 140 may be configured to output annotation data 144 associated with image data 120. In an embodiment, at least a first algorithm 140 may include one or more of the following algorithms: an algorithm configured to calculate a fitness measure of the image data 120 and flag the image data 120 accordingly, an algorithm configured to determine a quality metric from the image data 120, an algorithm configured to identify different cell groups in one or more image data 120, and/or an algorithm configured to generate a color gamut correction for one or more image data 120. At least a first algorithm 140 may include any algorithm as described specifically herein and/or any other algorithm constructed to aid in image processing and has an influence on a viewer's display of an image. Implementation of one or more of at least a first algorithm 140 may be assisted by a machine vision system as described above and/or any other imaging device as described throughout this disclosure.

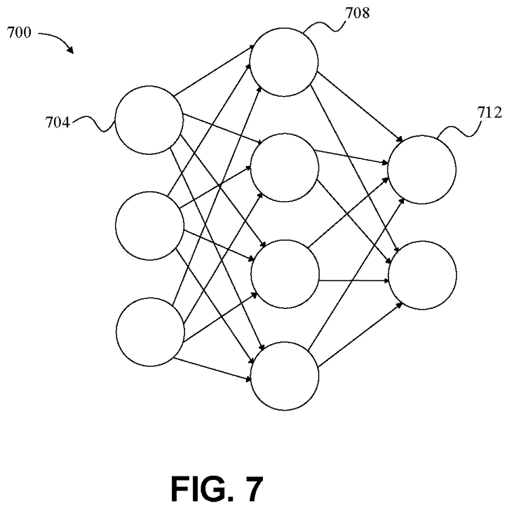

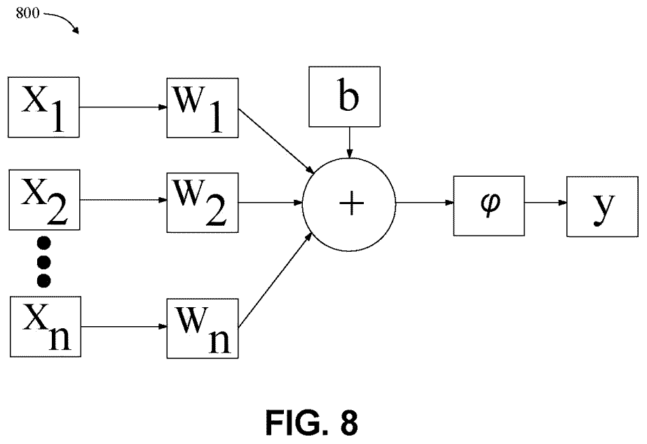

With continued reference to FIG. 1A, in an embodiment, and without limitation, machine learning module 132 may comprise a deep neural network (DNN). As used in this disclosure, a “deep neural network” is defined as a neural network with two or more hidden layers. Neural network is described in further detail below with reference to FIGS. 7-8. In a non-limiting example, machine learning module 132 may include a convolutional neural network (CNN). Generating exemplary outputs may include training CNN using the exemplary, nonlimiting training data listed for each individual algorithm. A “convolutional neural network,” for the purpose of this disclosure, is a neural network in which at least one hidden layer is a convolutional layer that convolves inputs to that layer with a subset of inputs known as a “kernel,” along with one or more additional layers such as pooling layers, fully connected layers, and the like. In some cases, CNN may include, without limitation, a deep neural network (DNN) extension. Mathematical (or convolution) operations performed in the convolutional layer may include convolution of two or more functions, where the kernel may be applied to input data e.g., any of the exemplary training data as described throughout this disclosure through a sliding window approach. In some cases, convolution operations may enable processor 108 to detect local/global patterns, edges, textures, and any other features described herein within. Spatial features may be passed through one or more activation functions, such as, without limitation, Rectified Linear Unit (ReLU), to introduce non-linearities into the processing step of generating exemplary outputs. Additionally, or alternatively, CNN may also include one or more pooling layers, wherein each pooling layer is configured to reduce the dimensionality of input data while preserving essential features within the input data. In a non-limiting example, CNN may include one or more pooling layer configured to reduce the dimensions of spatial feature maps by applying downsampling, such as max-pooling or average pooling, to small, non-overlapping regions of one or more features.

Still referring to FIG. 1A, CNN may further include one or more fully connected layers configured to combine features extracted by the convolutional and pooling layers as described above. In some cases, one or more fully connected layers may allow for higher-level pattern recognition. In a non-limiting example, one or more fully connected layers may connect every neuron (i.e., node) in its input to every neuron in its output, functioning as a traditional feedforward neural network layer. In some cases, one or more fully connected layers may be used at the end of CNN to perform high-level reasoning and produce the final output such as, without limitation, the exemplary outputs as described below in the context of each specific example. Further, each fully connected layer may be followed by one or more dropout layers configured to prevent overfitting, and one or more normalization layers to stabilize the learning process described herein.

With continued reference to FIG. 1A, in an embodiment, and without limitation a feature learning algorithm may be utilized to group divided image data 120 into categories. The grouped image data 120 may then be run through an image classifier, such as without limitation, a CNN. In some embodiments the CNN may label each section as a section to be displayed within data display structure 148 at interactive display device 160 and/or alternatively be used to create a more uniform grouping of categories. For example, and without limitation this may be used in color correction as described in further detail below. Additionally, this classification may be used to assist in any labeling process as described below in the context of an embodiment of at least a first algorithm 140. A “feature learning algorithm,” as used herein, is a machine-learning algorithm that identifies associations between elements of data in a data set, which may include without limitation a training data set, where particular outputs and/or inputs are not specified. For instance, and without limitation, a feature learning algorithm may detect co-occurrences of elements of data, as defined above, with each other. As a non-limiting example, feature learning algorithm may detect co-occurrences of elements, as defined above, with each other. Computing device may perform a feature learning algorithm by dividing elements or sets of data into various sub-combinations of such data to create new elements of data and evaluate which elements of data tend to co-occur with which other elements. In an embodiment, first feature learning algorithm may perform clustering of data. Clustering of data may be categorized based on the algorithm being implemented. For example, and without limitation, clusters may be categorized based on cell type, which may require a comparison of labeled data of specific cell types and unlabeled data of specific cell types.

Continuing refer to FIG. 1A, a feature learning and/or clustering algorithm may be implemented, as a non-limiting example, using a k-means clustering algorithm. A “k-means clustering algorithm” as used in this disclosure, includes cluster analysis that partitions n observations or unclassified cluster data entries into k clusters in which each observation or unclassified cluster data entry belongs to the cluster with the nearest mean. “Cluster analysis” as used in this disclosure, includes grouping a set of observations or data entries in way that observations or data entries in the same group or cluster are more similar to each other than to those in other groups or clusters. Cluster analysis may be performed by various cluster models that include connectivity models such as hierarchical clustering, centroid models such as k-means, distribution models such as multivariate normal distribution, density models such as density-based spatial clustering of applications with nose (DBSCAN) and ordering points to identify the clustering structure (OPTICS), subspace models such as biclustering, group models, graph-based models such as a clique, signed graph models, neural models, and the like. Cluster analysis may include hard clustering whereby each observation or unclassified cluster data entry belongs to a cluster or not. Cluster analysis may include soft clustering or fuzzy clustering whereby each observation or unclassified cluster data entry belongs to each cluster to a certain degree such as for example a likelihood of belonging to a cluster; for instance, and without limitation, a fuzzy clustering algorithm may be used to identify clustering of elements of a first type or category with elements of a second type or category, and vice versa. Cluster analysis may include strict partitioning clustering whereby each observation or unclassified cluster data entry belongs to exactly one cluster. Cluster analysis may include strict partitioning clustering with outliers whereby observations or unclassified cluster data entries may belong to no cluster and may be considered outliers. Cluster analysis may include overlapping clustering whereby observations or unclassified cluster data entries may belong to more than one cluster. Cluster analysis may include hierarchical clustering whereby observations or unclassified cluster data entries that belong to a child cluster also belong to a parent cluster.

With continued reference to FIG. 1A, computing device may generate a k-means clustering algorithm receiving unclassified data and outputs a definite number of classified data entry clusters wherein the data entry clusters each contain cluster data entries. K-means algorithm may select a specific number of groups or clusters to output, identified by a variable “k.” Generating a k-means clustering algorithm includes assigning inputs containing unclassified data to a “k-group” or “k-cluster” based on feature similarity. Centroids of k-groups or k-clusters may be utilized to generate classified data entry cluster. K-means clustering algorithm may select and/or be provided “k” variable by calculating k-means clustering algorithm for a range of k values and comparing results. K-means clustering algorithm may compare results across different values of k as the mean distance between cluster data entries and cluster centroid. K-means clustering algorithm may calculate mean distance to a centroid as a function of k value, and the location of where the rate of decrease starts to sharply shift, this may be utilized to select a k value. Centroids of k-groups or k-cluster include a collection of feature values which are utilized to classify data entry clusters containing cluster data entries. K-means clustering algorithm may act to identify clusters of closely related data, which may be provided with user cohort labels; this may, for instance, generate an initial set of user cohort labels from an initial set of data, and may also, upon subsequent iterations, identify new clusters to be provided new labels, to which additional data may be classified, or to which previously used data may be reclassified.

With continued reference to FIG. 1A, generating a k-means clustering algorithm may include generating initial estimates for k centroids which may be randomly generated or randomly selected from unclassified data input. K centroids may be utilized to define one or more clusters. K-means clustering algorithm may assign unclassified data to one or more k-centroids based on the squared Euclidean distance by first performing a data assigned step of unclassified data. K-means clustering algorithm may assign unclassified data to its nearest centroid based on the collection of centroids ci of centroids in set C. Unclassified data may be assigned to a cluster based on argmin_{ci} [symbol] _{C} dist(ci, x)², where argmin includes argument of the minimum, ci includes a collection of centroids in a set C, and dist includes standard Euclidean distance. K-means clustering module may then recompute centroids by taking mean of all cluster data entries assigned to a centroid's cluster. This may be calculated based on ci=1/|Si|Σxi [symbol] Si^{xi}. K-means clustering algorithm may continue to repeat these calculations until a stopping criterion has been satisfied such as when cluster data entries do not change clusters, the sum of the distances have been minimized, and/or some maximum number of iterations has been reached.

Still referring to FIG. 1A, k-means clustering algorithm may be configured to calculate a degree of similarity index value. A “degree of similarity index value” as used in this disclosure, includes a distance measurement indicating a measurement between each data entry cluster generated by k-means clustering algorithm and a selected element. Degree of similarity index value may indicate how close a particular combination of elements is to being classified by k-means algorithm to a particular cluster. K-means clustering algorithm may evaluate the distances of the combination of elements to the k-number of clusters output by k-means clustering algorithm. Short distances between an element of data and a cluster may indicate a higher degree of similarity between the element of data and a particular cluster. Longer distances between an element and a cluster may indicate a lower degree of similarity between a elements to be compared and/or clustered and a particular cluster.

With continued reference to FIG. 1A, k-means clustering algorithm selects a classified data entry cluster as a function of the degree of similarity index value. In an embodiment, k-means clustering algorithm may select a classified data entry cluster with the smallest degree of similarity index value indicating a high degree of similarity between an element and the data entry cluster. Alternatively or additionally k-means clustering algorithm may select a plurality of clusters having low degree of similarity index values to elements to be compared and/or clustered thereto, indicative of greater degrees of similarity. Degree of similarity index values may be compared to a threshold number indicating a minimal degree of relatedness suitable for inclusion of a set of element data in a cluster, where degree of similarity indices a-n falling under the threshold number may be included as indicative of high degrees of relatedness. The above-described illustration of feature learning using k-means clustering is included for illustrative purposes only and should not be construed as limiting potential implementation of feature learning algorithms; persons skilled in the art, upon reviewing the entirety of this disclosure, will be aware of various additional or alternative feature learning approaches that may be used consistently with this disclosure.

Further referencing FIG. 1A, at least a first algorithm 140 may include an algorithm configured to calculate a fitness measure of the image data 120 and flag the image data 120 accordingly. As used throughout this disclosure, “fitness measure” is a benchmark for meeting certain standards and/or criteria. In an embodiment an algorithm configured to calculate a fitness measure of the image data 120 and flag the image data 120 accordingly may work in tandem with an algorithm configured to determine a quality metric from the image data 120. An algorithm configured to calculate a fitness measure of the image data 120 and flag the image data 120 accordingly may be implemented, without limitation, as disclosed in U.S. application Ser. No. 18/226,017, filed on Jul. 25, 2023 and entitled “APPARATUS AND A METHOD FOR GENERATING A CONFIDENCE SCORE ASSOCIATED WITH A SCANNED LABEL” the entirety of which is incorporated herein by reference. When image data 120 is flagged, imaging device 124 may capture additional image data 120 and perform one or more of the algorithms described throughout this disclosure on the newly captured image data 120. This may include replacing the flagged image data 120 and/or integrating the image data 120 in accordance with one or more of the described methods in relation to at least a first algorithm 140.

Continuing to reference FIG. 1A, an algorithm configured to calculate a fitness measure of the image data 120 and flag the image data 120 accordingly may include training data 136 specific to such an embodiment of at least a first algorithm 140. Exemplary training data 136 may include, without limitation, inputs such as image data 120, flagged image data 120, fitness measurements, fitness measurement parameters, image data 120 parameters, rule-based actions correlated to fitness measurement parameters and image data 120 parameters, and/or the like correlated to outputs such as flagged image data 120, new image data 120 parameters, fitness measurements, and/or the like.

With further reference to FIG. 1A, at least a first algorithm 140 may include an algorithm configured to determine a quality metric from the image data 120. An algorithm configured to determine a quality metric from the image data 120 may be implemented, without limitation, as disclosed in U.S. application Ser. No. 18/602,947, filed on Mar. 12, 2024 and entitled “SYSTEMS AND METHODS FOR INLINE QUALITY CONTROL OF SLIDE DIGITIZATION” the entirety of which is incorporated herein by reference. Additionally, an algorithm configured to determine a quality metric from image data 120 may implement blur detection and/or focus detection. Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity, and a low score indicates blurriness. Blur detection may be performed using a Gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content. The quality of focus may be determined by analyzing a degree of focus at a portion of an image containing image data 120 of interest; this may be accomplished using any algorithm and/or operator as described above for blurriness detection and/or determination of degree of focus. Alternatively or additionally, a whole-image blurriness detection process with regard to a section of image containing image data 120 of interest. Quality level may be determined according to a degree of lightness, darkness, contrast, and/or another parameter. Machine learning module 132 may also analyze a series of image data 120 taken in rapid succession of the same subject matter, but at varying camera lens focal lengths, exposure times, and/or the like. In this case the machine learning module 132 may identify the most in-focus image corresponding to a selected region of the image. This may be implemented, without limitation, as disclosed in U.S. application Ser. No. 18/227,155, filed on Jul. 27, 2023 and entitled “METHOD OF AND SYSTEM FOR INLINE HEALTHCARE IMAGE ENRICHMENT” the entirety of which is incorporated herein by reference. Further, an algorithm configured to determine a quality metric from image data 120 may additionally implement a process to correct image data 120 using other captured image data 120 of related matter. This may be implemented, without limitation, as disclosed in U.S. application Ser. No. 18/603,051, filed on Mar. 12, 2024 and entitled “SYSTEMS AND METHODS FOR DIGITIZATION OF TISSUE SLIDES BASED ON ASSOCIATIONS AMONG SERIAL SECTIONS” the entirety of which is incorporated herein by reference. In some embodiments, this algorithm may additionally generate scanning parameters to be used to recapture image data 120 in accordance with the quality level.

Continuing to reference FIG. 1A, at least a first algorithm 140 may include an algorithm configured to identify different cell groups in one or more image data 120. This may be implemented, without limitation, as disclosed in U.S. application Ser. No. 18/602,776, filed on Mar. 12, 2024 and entitled “SYSTEMS AND METHODS FOR DETECTION OF PATHOLOGICAL FEATURES DURING SLIDE DIGITIZATION” the entirety of which is incorporated herein by reference. Additionally, in an embodiment, the algorithm may utilize machine or computer vision configured to identify different cell groups. An algorithm configured to identify different cell groups in one or more image data 120 may utilize image classification and/or object detection techniques. For example, and without limitation, in an embodiment, a first algorithm that includes an algorithm configured to identify different cell groups may utilize edge detection, resizing, decimation, interpolation, and/or the like. In some embodiments, specific implementations of an algorithm configured to identify different cell groups may include dividing an image into pieces using one or more of the following: edge detection, average chroma and/or luma value, a grid of rectangles and/or other polygons or even curved shapes. Further, in some embodiments, these divisions may then be run through a classifier using particle swarm optimization, k-means clustering, and/or other clustering and/or unsupervised machine learning process to group pixels into categories. Categories may include chroma and luma. Further clustering may be based on labeled image data 120, for example, and without limitation clusters may be created based on categorization of cell types. Alternatively, the divisions may be input into a neural network that is trained to find the regions of interest in an image. In some embodiments, neural network may include a nuclei detection neural network. Nuclei detection neural networks may include, as non-limiting examples, DenseUNet, UNet, Mask R-CNN neural networks, and the like. In some embodiments, neural network may include one or more tumor localization models which may be configured to locate tumors. In some embodiments, neural networks may include a neural network configured to detect mitotic nuclei. An algorithm configured to identify different cell groups may utilize image classification techniques that include supervised and/or unsupervised processes. Further an algorithm configured to identify different cell groups may instantiate machine learning module 132 to identify different cell groups. Machine learning module 132 may include a machine learning model and/or a neural network. In an embodiment, machine learning module 132 may be, or include a convolutional neural network. Exemplary training data 136 may include, without limitation, inputs such as image data 120 containing one or more cell groups, image data 120 containing one or more cell groups and additional background noise, such as bubbles, extra stain, and/or the like, labeled or classified image data 120 containing one cell group, labeled or classified image data 120 containing more than one cell group, and/or the like and correlated to outputs such as image data 120 identifying different cell groups, labeled or classified image data 120 containing one cell group, labeled or classified image data 120 containing more than one cell group. Outputs of machine learning module 132 may be used reiteratively as new training data 136. Training of machine learning module 132 may take place at computing device 104 and/or remotely. Likewise, retraining of machine learning module 132 may take place at computing device 104 and/or remotely.

With continued reference to FIG. 1A, at least a first algorithm 140 may include an algorithm configured to generate a color gamut correction for one or more image data 120. An algorithm configured to generate a color gamut correction for one or more image data 120 may be implemented, without limitation, as disclosed in U.S. application Ser. No. 18/513,079, filed on Nov. 22, 2023 and entitled “SYSTEM AND METHOD FOR COLOR GAMUT NORMALIZATION FOR PATHOLOGY SLIDES” the entirety of which is incorporated herein by reference.

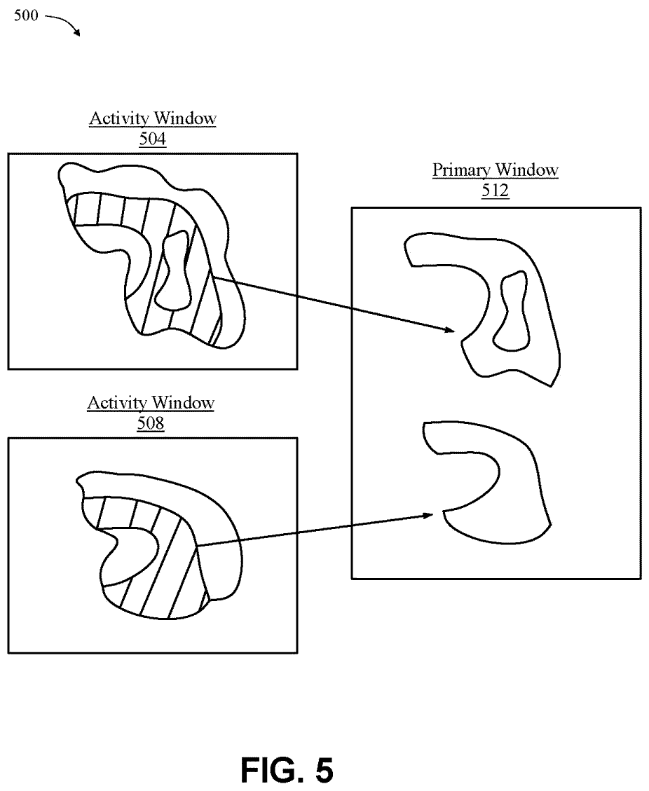

Further referencing FIG. 1A, system 100a may be configured to generate display data structure 148. Display data structure 148 may include at least a primary window 152 and an activity window 156. In some embodiments, display data structure 148 may include primary window 152 and one or more activity windows 156. For example, and without limitation see FIG. 5 for a particular implementation of this embodiment. Further, in some embodiments display data structure 148 may include one or more primary windows 152 and/or one or more activity windows 156. The embodiment of display data structure 148 may depend on a user's inputs and/or preferences. As used throughout this disclosure, “primary window” is the visualization of image data 120 without overlay of metadata. Metadata may include metadata that is descriptive, administrative, and/or structural. For example, and without limitation, metadata may include annotation data 144. Annotation data 144 may include notes, dates, titles, file sizes, mask overlays, and/or the like. As used throughout this disclosure, “activity window” is the visualization of image data 120 with overlay of metadata. In some embodiments, activity window 156 may further include one or more adaptive overlays with metadata at varying levels of magnification. Adaptive overlays may include transparent masks with overlay information, contours with overlay information, dots of various sizes with information, and/or the like. Adaptive overlays may be at varying magnification levels, such as high magnification, intermediate magnification, and/or lower magnification. In some embodiments, display data structure 148 may display primary window 152 and activity window 156 in a side-by-side manner. Wherein primary window 152 and activity window 156 are both shown at interactive display device 160. Further, in some embodiments, display data structure 148 may include adjacent image data 120 to primary window 152 and activity window 156 including altered image data 120. “Altered image data,” as used herein, refers to image data 120 that includes an additional and or different limitation in comparison to the original image data 120. For example, and without limitation, in some embodiments, where image data 120 includes one or more scanned tissue slides, the altered image data 120 may include one or more tissue slides with a different and/or no stain.

With continued reference to FIG. 1A, in some embodiments, system 100a may further be configured to accept user input 164 at interactive display device 160. User input 164 may include selecting an area of interest of image data 120, zooming in and/or out, panning across image data 120, highlighting, typing, clicking, and/or the like. For example, and without limitation, in some embodiments, system 100a may be further configured to accept user input 164, selecting a region of interest of image data 120, display at primary window 152, the selected region of interest of image data 120, and enable the user, at interactive display device 160, to zoom, pan, or otherwise interact with the region of interest of image data 120. In some embodiments, user input 164 may include the use of image segmentation tools. For example, in some embodiments, system 100a may be further configured to accept user input 164 of multiple segments of interest from display data structure 148, composite a virtual composite image from the selected segments of interest, and display the virtual composite image at primary window 152. In some embodiments, a user may toggle between metadata displayed on activity window 156 at interactive display device 160. This may enable a user to choose particular metadata displayed at primary window 152.

With further reference to FIG. 1A, interactive display device 160 may be configured to display to a user the generated display data structure 148 generated at computing device 104. In some embodiments this may be accomplished via a graphical user interface (GUI) configured to display data structure 148 at interactive display device 160. Interactive display device 160 may be communicatively connected to computing device. User input 164 may update display data structure 148. For example, and without limitation, updates to primary window 152 may occur based on interaction with activity window 156 and its associated metadata. In some embodiments, this may be accomplished using event handlers. Interactive display device 160 may be any display device as described throughout this disclosure.

Still referring to FIG. 1A, in some embodiments, computing device 104 may be configured to configure interactive display device 160 to display an event handler graphic corresponding to a data-reception event handler. As used in this disclosure, an “event handler graphic” is a graphical element with which a user of remote device may interact to enter data, for instance and without limitation for a search query or the like as described in further detail below. An event handler graphic may include, without limitation, a button, a link, a checkbox, a text entry box and/or window, a drop-down list, a slider, or any other event handler graphic that may occur to a person skilled in the art upon reviewing the entirety of this disclosure. An “event handler,” as used in this disclosure, is a module, data structure, function, and/or routine that performs an action on remote device in response to a user interaction with event handler graphic. For instance, and without limitation, an event handler may record data corresponding to user selections of previously populated fields such as drop-down lists and/or text auto-complete and/or default entries, data corresponding to user selections of checkboxes, radio buttons, or the like, potentially along with automatically entered data triggered by such selections, user entry of textual data using a keyboard, touchscreen, speech-to-text program, or the like. Event handler may generate prompts for further information, may compare data to validation rules such as requirements that the data in question be entered within certain numerical ranges, and/or may modify data and/or generate warnings to a user in response to such requirements. An event handler may convert data into expected and/or desired formats, for instance such as date formats, currency entry formats, name formats, or the like. Event handler may transmit data from remote device to computing device 104.

In an embodiment, and continuing to refer to FIG. 1A, event handler may include a cross-session state variable. As used herein, a “cross-session state variable” is a variable recording data entered on remote device during a previous session. Such data may include, for instance, previously entered text, previous selections of one or more elements as described above, or the like. For instance, cross-session state variable data may represent a search a user entered in a past session. Cross-session state variable may be saved using any suitable combination of client-side data storage on remote device and server-side data storage on computing device 104; for instance, data may be saved wholly or in part as a “cookie” which may include data or an identification of remote device to prompt provision of cross-session state variable by computing device 104, which may store the data on computing device 104. Alternatively, or additionally, computing device 104 may use login credentials, device identifier, and/or device fingerprint data to retrieve cross-session state variable, which computing device 104 may transmit to remote device. Cross-session state variable may include at least a prior session datum. A “prior session datum” may include any element of data that may be stored in a cross-session state variable. An event handler graphic may be further configured to display the at least a prior session datum, for instance and without limitation auto-populating user query data from previous sessions.

With continued reference to FIG. 1A, system 100a may include a computing device. Computing device 104 includes a processor communicatively connected to a memory. As used in this disclosure, “communicatively connected” means connected by way of a connection, attachment or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Further referring to FIG. 1A, computing device 104 may include any computing device as described in this disclosure, including without limitation a microcontroller, microprocessor, digital signal processor (DSP) and/or system on a chip (SoC) as described in this disclosure. Computing device 104 may include, be included in, and/or communicate with a mobile device such as a mobile telephone or smartphone. Computing device 104 may include a single computing device operating independently, or may include two or more computing device operating in concert, in parallel, sequentially or the like; two or more computing devices may be included together in a single computing device or in two or more computing devices. Computing device 104 may interface or communicate with one or more additional devices as described below in further detail via a network interface device. Network interface device may be utilized for connecting computing device 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device 104 may include but is not limited to, for example, a computing device or cluster of computing devices in a first location and a second computing device or cluster of computing devices in a second location. Computing device 104 may include one or more computing devices dedicated to data storage, security, distribution of traffic for load balancing, and the like. Computing device 104 may distribute one or more computing tasks as described below across a plurality of computing devices of computing device, which may operate in parallel, in series, redundantly, or in any other manner used for distribution of tasks or memory between computing devices. Computing device 104 may be implemented, as a non-limiting example, using a “shared nothing” architecture.

With continued reference to FIG. 1A, computing device 104 may be designed and/or configured to perform any method, method step, or sequence of method steps in any embodiment described in this disclosure, in any order and with any degree of repetition. For instance, computing device 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Referring now to FIG. 1B, a block diagram of an exemplary embodiment of a system 100b for augmented visualization using activity windows is illustrated. In some cases, system 100b may be consistent with system 100a. In some embodiments, system 100b may incorporate system 100a. System 100b for augmented visualization using activity windows 152 includes at least a processor 108, a memory 112 communicatively connected to the at least a processor 108. Memory 112 contains instructions configuring the at least a processor 108 to perform operations associated with receiving image data 120, generating a display data structure 148, instantiating one or more AI agents 168, retrieving external data 172, generating agent outputs 176, and updating the display data structure 148 as described herein. In system 100b, display data structure 148 includes at least an activity window 156 configured to display derived content associated with image data 120.

With continued reference to FIG. 1B, processor 108 is configured to receive image data 120. In some embodiments, image data 120 may include digitized pathology images, whole-slide images, microscopy images, radiology images, or other medical or scientific images. For example, and without limitation, image data 120 may include a digitized tissue slide generated by scanning a glass pathology slide using an optical scanner. In some embodiments, image data 120 may be received from an imaging device 124, a storage device 128, or a remote computing system. For example, and without limitation, image data 120 may be retrieved from a pathology image archive, a hospital picture archiving and communication system (PACS), or a cloud-based storage repository.

With continued reference to FIG. 1B, processor 108 is configured to generate a display data structure 148. Display data structure 148 includes at least an activity window 156 configured to display derived content associated with image data 120. For the purposes of this disclosure, “derived content” of image data is information generated, computed, inferred, synthesized, or selected related to at least image data 120. Derived content may include outputs that are not part of the original image data 120 and that convey analytical, interpretive, or contextual information associated with the image data 120. In some embodiments, derived content displayed within activity window 156 may include one or more agent outputs 176 generated by one or more AI agents 168. For example, and without limitation, derived content may include natural language outputs 180 generated by one or more LLM agents 182 that explain, summarize, or contextualize features of image data 120, processing outputs 184 generated by one or more image processing agents 186 such as annotations, segmentation masks, or region-of-interest indicators, deterministic outputs 188 generated by one or more deterministic agents 190 such as determinations regarding anatomical features, pathological conditions, or responses to questions included in user input, synthesized representations of external data 172 retrieved from external data sources 192, or combinations thereof.

With continued reference to FIG. 1B, in some embodiments, activity window 156 may be rendered adjacent to, overlaid on, or dynamically repositioned relative to image data 120 within the user interface 194. For example, and without limitation, activity window 156 may appear as a side panel presenting derived content while image data 120 is displayed in a primary window, may appear as a collapsible overlay aligned with a selected region of interest within image data 120, or may be dynamically repositioned or resized as a function of user interaction or agent outputs 176 to emphasize relationships between derived content and corresponding portions of image data 120.

With continued reference to FIG. 1B, in some embodiments, display data structure 148 may include a primary window 152 configured to display image data 120. In some embodiments, display data structure 148 may include one or more interactive elements 196 associated with the primary window 152 and the activity window 156. For the purposes of this disclosure, “interactive elements” are interface constructs configured to receive user interaction and generate corresponding computational events. In some cases, interactive elements 196 may include buttons, selectable regions, text input fields, sliders, menus, toggles, or other graphical controls. For example, and without limitation, an interactive element 196 may include a user input field configured to receive a search query associated with image data 120.

With continued reference to FIG. 1B, interactive display device 160 may be configured to render a user interface 194 including display data structure 148. In some cases, system 100b for augmented visualization using activity windows 152 may include an interactive display device 160. In some cases, interactive display device 160 may render a user interface 194. For the purposes of this disclosure, a “user interface” is a means by which a user and a computer system interact. For example through the use of input devices and software. A user interface 194 may include a graphical user interface (GUI), command line interface (CLI), menu-driven user interface, touch user interface, voice user interface (VUI), form-based user interface, any combination thereof and the like. In some embodiments, user interface 194 may operate on and/or be communicatively connected to a decentralized platform, metaverse, and/or a decentralized exchange platform associated with the user. For example, a user may interact with user interface 194 in virtual reality. In some embodiments, a user may interact with the user interface 194 using a computing device distinct from and communicatively connected to at least a processor 108. For example, a smart phone, smart, tablet, or laptop operated by a user. In an embodiment, user interface 194 may include a graphical user interface. A “graphical user interface,” as used herein, is a graphical form of user interface that allows users to interact with electronic devices. In some embodiments, GUI may include icons, menus, other visual indicators or representations (graphics), audio indicators such as primary notation, and display information and related user controls. A menu may contain a list of choices and may allow users to select one from them. A menu bar may be displayed horizontally across the screen such as pull-down menu. When any option is clicked in this menu, then the pull-down menu may appear. A menu may include a context menu that appears only when the user performs a specific action. An example of this is pressing the right mouse button. When this is done, a menu may appear under the cursor. Files, programs, web pages and the like may be represented using a small picture in a graphical user interface. For example, links to decentralized platforms as described in this disclosure may be incorporated using icons. Using an icon may be a fast way to open documents, run program, and the like because clicking on them yields instant access. In some cases, user interface 194 may be rendered at interactive display device 160 that enable a user to provide input to and receive output from computing device 104, In some embodiments, the user interface 194 may include a display data structure 148 comprising at least an activity window 156 configured to display derived content associated with image data 120 and a primary window 152 configured to display image data 120, wherein one or more interactive elements 196 are associated with the activity window 156 and, where present, the primary window 152.

With continued reference to FIG. 1B, processor 108 is configured to receive user input 164 in response to user interaction with the user interface 194, wherein user input 164 is associated with image data 120. For the purposes of this disclosure, “user interaction” is an action performed by a user through the user interface 194 that causes generation of an event or signal processed by processor 108. In some cases, the user interaction may include selection, activation, modification, or entry of information through one or more interactive elements 196. User input 164 may include, for example and without limitation, selecting a region of image data 120, selecting a region of interest within image data 120, entering a textual query, selecting a predefined option, or selecting an interactive element 196 associated with the activity window or a primary window. As a non-limiting example, user input 164 may further include a follow-up query refining a prior query entered through the search interface, a confirmation or rejection of a determination generated by one or more deterministic agents 190, a selection of a natural language output 180 presented within the activity window to request additional explanation or supporting evidence, a request to retrieve additional external data 172 from one or more external data sources 192, a selection of a specific processing output 184 such as an annotation or region-of-interest indicator to focus subsequent analysis, a request to compare multiple regions of interest within image data 120, a request to identify an anatomical feature or pathological condition associated with a selected region of image data 120, a request to generate a summarized or synthesized interpretation of previously retrieved external data 172, a request to modify a presentation state of the activity window 156 or a primary window 152, including zoom level, spatial alignment, or visibility of derived content, thereby enabling iterative, query-driven interaction with image data 120 and continued execution of one or more AI agents 168, or any questions or requests related to image data 120.

With continued reference to FIG. 1B, in some embodiments, receiving user input 164 may include receiving the user input 164 using a user input field of one or more interactive elements 196. For the purposes of this disclosure, “user input field” is an interface component configured to receive structured or unstructured information entered by a user through the user interface 194 and to transmit the entered information to processor 108. In some embodiments, the user input field includes a search interface. For the purposes of this disclosure, “search interface” is a user input field configured to accept query information. In some cases, search interface may initiate retrieval, filtering, or synthesis of external data 172 and generation of agent outputs 176 by one or more AI agents 168 as a function of the query information. In some embodiments, the search interface may enable query-driven interaction with image data 120 by allowing a user to request information related to features, regions, conditions, anatomical structures, or interpretations associated with the image data 120 and to retrieve corresponding external data 172 for correlation and presentation within the activity window.

With continued reference to FIG. 1B, processor 108 instantiates one or more AI agents 168 within the activity window 156. For the purposes of this disclosure, “artificial intelligence agents” are software entities that perform one or more reasoning operations over one or more inputs. In some cases, instantiating AI agents 168 may include allocating computational resources, loading one or more trained models, initializing agent state variables, and enabling access to tools or data sources required for agent execution. In some embodiments, one or more AI agents 168 may include one or more image processing agents 186. For the purposes of this disclosure, “image processing agents” are AI agents configured to generate image-derived information from image data 120. In some cases, image processing agents 186 may include convolutional neural networks, transformer-based vision models, or hybrid architectures combining convolutional and attention-based layers. For example, and without limitation, an image processing agent 186 may include a U-Net architecture trained to perform tissue segmentation. In some cases, image processing agents 186 may generate processing outputs 184. In some cases, image processing agents 186 may include imaging processing module, machine vision module, and the like. For the purposes of this disclosure, “processing outputs” are outputs generated using one or more image processing agents. Processing outputs 184 may include annotation data associated with image data 120. In some cases, annotation data may include segmentation masks, detected cell boundaries, region-of-interest coordinates, confidence scores, or feature vectors. In some embodiments, processing outputs 184 serve as inputs to other AI agents 168. In some cases, training data for image processing agents 186 may include labeled pathology slides, annotated microscopy images, and synthetic training data generated through augmentation. Training data sources may include institutional datasets, publicly available pathology datasets, and curated expert-labeled image repositories.

With continued reference to FIG. 1B, in some cases, processor 108 may be configured to analyze image data 120 using an image processing module. In some embodiments, image data 120 may include medical or scientific imagery, including without limitation digitized pathology slides, microscopy images, histological images, radiology images, or other biomedical images. In a non-limiting example, image data 120 may include one or more whole-slide images depicting biological tissue, cellular structures, or anatomical regions, and image processing module may perform feature extraction to identify visual attributes such as cellular morphology, tissue boundaries, staining patterns, spatial organization of cells, anatomical landmarks, or pathological features. In some embodiments, processor 108 may apply one or more computer vision techniques, including object detection, image segmentation, pattern recognition, or feature extraction, to detect relevant visual elements within image data and convert those elements into structured data elements, which may then be integrated into image data 120 for further processing by one or more AI agents. As used in this disclosure, an “image processing module” is one or more image processing techniques designed to perform specific processing tasks or operations on a digital image. For example, and without limitation, image processing module may be configured to compile a plurality of digital images corresponding to serial tissue sections to create an integrated or composite image representation. In some embodiments, image processing module includes a plurality of software algorithms configured to analyze, manipulate, or enhance image data, including operations related to image normalization, alignment, segmentation, annotation generation, and region-of-interest extraction. Image processing module may include, be included in, or be communicatively connected to processor 108 and/or memory 112.

With continued reference to FIG. 1B, in some embodiments, image processing module may be configured to compress and/or encode image data to reduce file size and storage requirements while maintaining essential visual information needed for downstream processing, visualization, and analysis. In some embodiments, compression and/or encoding facilitates faster transmission of image data between computing components or remote systems, including transmission to interactive display devices. In some cases, image processing module may perform lossless compression to preserve diagnostic image quality, wherein lossless compression maintains original spatial resolution, color fidelity, and pixel-level information. In a non-limiting example, image processing module may utilize lossless compression algorithms including Huffman coding, Lempel-Ziv-Welch (LZW), Run-Length Encoding (RLE), or similar techniques, and may encode images using formats such as PNG or lossless JPEG2000. In other embodiments, image processing module may perform lossy compression to reduce data size while preserving clinically relevant features, wherein lossy compression may discard image information deemed non-essential for visualization or analysis. In a non-limiting example, lossy compression may utilize discrete cosine transform (DCT) or wavelet-based compression techniques, and may encode images using formats such as JPEG or WebP, provided that diagnostically relevant features remain visually discernible.

With continued reference to FIG. 1B, in some embodiments, processing image data 120 may include determining a degree of quality of depiction of a region of interest within an image or across a plurality of images. In some embodiments, image processing module may determine a degree of focus or blurriness associated with image data, particularly in regions containing diagnostically relevant structures. In a non-limiting example, blur detection may be performed by computing a Fourier transform or fast Fourier transform (FFT) of image data and analyzing distributions of high-frequency components, wherein reduced high-frequency content may indicate blur. In another non-limiting example, blur detection may be performed using a Laplacian operator to generate a numerical focus score reflecting intensity transitions within the image. In other embodiments, image processing module may use gradient-based operators, wavelet-based operators, statistics-based texture descriptors, or discrete cosine transform (DCT) coefficients to assess image quality. In some embodiments, image processing module ranks image tiles or regions according to quality metrics and selects higher-quality regions or images for further analysis by AI agents.

With continued reference to FIG. 1B, in some embodiments, processing image data includes enhancing a region of interest using one or more image processing techniques to improve the quality of depiction for analysis and visualization. In some embodiments, image processing module performs noise reduction operations to reduce sensor noise, staining artifacts, compression artifacts, or background irregularities. In a non-limiting example, noise reduction may be performed using Gaussian filtering, median filtering, bilateral filtering, or similar filtering techniques, wherein pixel values are averaged or smoothed within local neighborhoods to reduce random variations while preserving structural features relevant to tissue analysis.

With continued reference to FIG. 1B, in some embodiments, image processing module may be configured to perform contrast enhancement operations on image data to improve visibility of anatomical or pathological features. In some cases, low contrast between tissue structures and background may hinder interpretation. Contrast enhancement operations may include histogram equalization, adaptive histogram equalization (CLAHE), contrast stretching, or brightness normalization. In a non-limiting example, brightness normalization may adjust pixel intensity values such that a region of interest exhibits consistent brightness across the image, thereby improving feature discrimination and aiding downstream segmentation or classification.

With continued reference to FIG. 1B, in some embodiments, image processing module may be configured to perform color space conversion operations to improve feature visibility. In a non-limiting example, color pathology images may be converted from RGB color space to grayscale, HSV, or other color representations to emphasize intensity variations or staining differences. In some embodiments, image processing module performs image sharpening operations, including unsharp masking, Laplacian sharpening, or high-pass filtering, to enhance edges and fine structural details associated with cells, tissue boundaries, or anatomical features.

With continued reference to FIG. 1B, processing image data may include isolating one or more regions or features of interest from the remainder of an image using a plurality of image processing techniques. In some embodiments, isolating a region of interest includes applying morphological operations such as dilation, erosion, opening, or closing to refine boundaries, remove noise, or fill gaps within segmented structures. In a non-limiting example, dilation may expand boundaries of detected cellular regions, while erosion may remove spurious artifacts, and opening or closing operations may smooth region contours prior to further analysis.

With continued reference to FIG. 1B, in some embodiments, isolating a region or feature of interest includes utilizing one or more edge detection techniques to identify structural boundaries within image data. Edge detection techniques may include Canny, Sobel, Prewitt, Laplacian, or phase congruency-based methods. In some embodiments, detected edges correspond to cell membranes, tissue interfaces, vascular boundaries, or anatomical contours, enabling identification of closed regions or structural features relevant to diagnostic interpretation.

With continued reference to FIG. 1B, in a non-limiting example, identifying one or more features from image data 120 includes isolating one or more areas of interest containing diagnostically relevant information. Areas outside an area of interest may include background tissue, slide artifacts, or irrelevant structures and may be disregarded to concentrate computational resources on relevant regions. In some embodiments, an area of interest is defined by spatial coordinates, bounding boxes, polygons, or segmentation masks. In a non-limiting example, image processing module crops or tiles image data to isolate a region of interest corresponding to suspected pathological tissue.

With continued reference to FIG. 1B, in some embodiments, image processing module may be configured to perform connected component analysis to identify and extract features of interest from image data. Connected component analysis may be applied to binary or thresholded images to identify connected regions corresponding to cells, nuclei, glands, or other structures. In some embodiments, image processing module filters connected components based on properties such as size, shape, aspect ratio, or intensity characteristics to retain components corresponding to features of interest. Extracted regions may then be transmitted to processor 108 for further processing by one or more AI agents 168, including image processing agents 186, deterministic agents 190, or LLM agents 182, in accordance with the systems and methods described herein.

With continued reference to FIG. 1B, in some embodiments, one or more AI agents 168 may include one or more large language model (LLM) agents 182. For the purposes of this disclosure, “LLM agents” are AI agents configured to perform reasoning operations using one or more large language models. In some cases, LLM agents 182 may receive as inputs external data 172, processing outputs 184, and image data 120. LLM agents 182 may correlate these inputs to generate natural language outputs 180. In some cases, executing the one or more AI agents 168 may include correlating, using a large language model (LLM) agent 182 of the one or more AI agents 168, the external data 172, the one or more processing outputs 184 and the image data 120 and generating, using the LLM agent 182, one or more natural language outputs 180 of the one or more agent outputs 176 as a function of the correlations among the external data 172, the one or more processing outputs 184 and the image data 120. For the purposes of this disclosure, “natural language outputs” are agent outputs expressed in human-readable text. In some cases, LLM agents 182 may be trained using large-scale textual corpora, medical literature, clinical notes, and domain-specific ontologies. Training data sources may include peer-reviewed publications, de-identified clinical records, and curated medical knowledge bases. In some embodiments, LLM agents 182 correlate the external data 172, the processing outputs 184, and the image data 120 by jointly reasoning over textual, numerical, and spatial representations of the inputs to generate one or more natural language outputs 180. In some embodiments, natural language outputs 180 may include explanatory text describing features detected within image data 120, interpretive summaries of processing outputs 184, answers to questions included in user input 164, comparative analyses between regions of interest within image data 120, or synthesized explanations that integrate image-derived findings with external data 172. As a non-limiting example, a natural language output 180 may include a textual explanation indicating that a selected region of interest exhibits cellular morphology consistent with a particular tissue type or pathological condition based on processing outputs 184 and correlated external data 172. As another non-limiting example, a natural language output 180 may include a response to a user query explaining relationships among detected annotations, segmentation results, or anatomical features within image data 120 and reference information retrieved from medical literature, clinical records, or other sources included in external data 172. In some embodiments, LLM agents 182 may use processing outputs 184, such as region-of-interest coordinates, segmentation masks, feature classifications, or confidence scores, to ground textual reasoning in spatial and visual characteristics of image data 120. In some embodiments, LLM agents 182 may use external data 172, including clinical records, radiology reports, laboratory results, pathology reports, or published reference materials, to contextualize or validate interpretations derived from image data 120. In some embodiments, LLM agents 182 may generate natural language outputs 180 that reference relationships between detected image features, corresponding anatomical structures, and information retrieved from one or more external data sources 192, thereby enabling integrated and explainable analysis presented through the activity window.

With continued reference to FIG. 1B, in some cases, LLM agent 182 may include or incorporate LLM. A “large language model,” as used herein, is a deep learning data structure that can recognize, summarize, translate, predict and/or generate text and other content based on knowledge gained from massive datasets. Large language models may be trained on large sets of data. Training sets may be drawn from diverse sets of data such as, as non-limiting examples, novels, blog posts, articles, emails, unstructured data, electronic records, and the like. In some embodiments, training sets may include a variety of subject matters, such as, as nonlimiting examples, medical report documents, electronic health records, entity documents, business documents, inventory documentation, emails, user communications, advertising documents, newspaper articles, and the like. In some embodiments, training sets of an LLM may include information from one or more public or private databases. As a non-limiting example, training sets may include databases associated with an entity, including clinical documentation repositories associated with a medical institution. In some embodiments, training sets may include portions of documents associated with the electronic records correlated to examples of outputs, including example question-and-answer outputs responsive to user queries associated with image data 120 displayed within an activity window. In an embodiment, an LLM may include one or more architectures based on capability requirements of an LLM. Exemplary architectures may include, without limitation, GPT (Generative Pretrained Transformer), BERT (Bidirectional Encoder Representations from Transformers), T5 (Text-To-Text Transfer Transformer), and the like. Architecture choice may depend on a needed capability such generative, contextual, or other specific capabilities, including generation of natural language outputs 180 derived from correlations among external data 172, processing outputs 184, and image data 120.

With continued reference to FIG. 1B, in some embodiments an LLM may include and/or be produced using Generative Pretrained Transformer (GPT), GPT-2, GPT-3, GPT-4, and the like. GPT, GPT-2, GPT-3, GPT-3.5, and GPT-4 are products of Open AI Inc., of San Francisco, CA. An LLM may include a text prediction based algorithm configured to receive an article and apply a probability distribution to the words already typed in a sentence to work out the most likely word to come next in augmented articles. For example, if some words that have already been typed are “Nice to meet,” then it may be highly likely that the word “you” will come next. As a further non-limiting example, if some words that have already been typed in a user query associated with image data 120 are “summarize findings in,” then it may be highly likely that subsequent words correspond to a selected region of interest, a tissue type, or an anatomical feature referenced in the user input and associated with image data 120. An LLM may output such predictions by ranking words by likelihood or a prompt parameter. For the example given above, an LLM may score “you” as the most likely, “your” as the next most likely, “his” or “her” next, and the like. In some embodiments, when the input corresponds to an image-related query, the LLM may score candidate terms associated with processing outputs 184 or external data 172 as higher-likelihood continuations of the sentence. An LLM may include an encoder component and a decoder component.

Still referring to FIG. 1B, LLM may include an attention mechanism, utilizing a transformer as described further below. An “attention mechanism,” as used herein, is a part of a neural architecture that enables a system to dynamically highlight relevant features of the input data. In natural language processing this may be a sequence of textual elements. It may be applied directly to the raw input or to its higher-level representation. An attention mechanism may be an improvement to the limitation of the Encoder-Decoder model which encodes the input sequence to one fixed length vector from which to decode the output at each time step. This issue may be seen as a problem when decoding long sequences because it may make it difficult for the neural network to cope with long sentences, such as those that are longer than the sentences in the training corpus. Applying an attention mechanism, LLM may predict the next word by searching for a set of position in a source sentence where the most relevant information is concentrated. In some embodiments, the source sentence may include user input received via a search interface, and the most relevant information may include terms describing a region of interest, a suspected condition, or a data source to be queried for external data 172. LLM may then predict the next word based on context vectors associated with these source positions and all the previous generated target words, such as textual data of a dictionary correlated to a prompt in a training data set. A “context vector,” as used herein, are fixed-length vector representations useful for document retrieval and word sense disambiguation. In some embodiments, LLM may include encoder-decoder model incorporating an attention mechanism.

Still referring to FIG. 1B, LLM may include a transformer architecture. In some embodiments, encoder component of LLM may include transformer architecture. A “transformer architecture,” for the purposes of this disclosure is a neural network architecture that uses self-attention and positional encoding. Transformer architecture may be designed to process sequential input data, such as natural language, with applications towards tasks such as translation and text summarization. Transformer architecture may process the entire input all at once. In some embodiments, the input may include a user query associated with image data 120 and accompanying context derived from external data 172 and processing outputs 184. “Positional encoding,” for the purposes of this disclosure, refers to a data processing technique that encodes the location or position of an entity in a sequence. In some embodiments, each position in the sequence may be assigned a unique representation. In some embodiments, positional encoding may include mapping each position in the sequence to a position vector. In some embodiments, trigonometric functions, such as sine and cosine, may be used to determine the values in the position vector. In some embodiments, position vectors for a plurality of positions in a sequence may be assembled into a position matrix, wherein each row of position matrix may represent a position in the sequence.

With continued reference to FIG. 1B, attention mechanism may represent an improvement over a limitation of an encoder-decoder model. An encoder-decider model encodes an input sequence to one fixed length vector from which the output is decoded at each time step. This issue may be seen as a problem when decoding long sequences because it may make it difficult for the neural network to cope with long sentences, such as those that are longer than the sentences in the training corpus. Applying an attention mechanism, an LLM may predict the next word by searching for a set of positions in a source sentence where the most relevant information is concentrated. In some embodiments, when user input includes a multi-part query associated with image data 120 and one or more external data sources 192, attention may concentrate on query terms that define constraints, such as a specified anatomical region, a requested diagnostic criterion, or a requested external record type. An LLM may then predict the next word based on context vectors associated with these source positions and all the previously generated target words, such as textual data of a dictionary correlated to a prompt in a training data set. A “context vector,” as used herein, are fixed-length vector representations useful for document retrieval and word sense disambiguation.

Still referring to FIG. 1B, attention mechanism may include, without limitation, generalized attention self-attention, multi-head attention, additive attention, global attention, and the like. In generalized attention, when a sequence of words or an image is fed to an LLM, it may verify each element of the input sequence and compare it against the output sequence. In some embodiments, the input sequence may include a query entered through a search interface and text derived from external data 172, and the output sequence may include natural language outputs 180 displayed in the activity window. Each iteration may involve the mechanism's encoder capturing the input sequence and comparing it with each element of the decoder's sequence. From the comparison scores, the mechanism may then select the words or parts of the image that it needs to pay attention to. In self-attention, an LLM may pick up particular parts at different positions in the input sequence and over time compute an initial composition of the output sequence. In multi-head attention, an LLM may include a transformer model of an attention mechanism. Attention mechanisms, as described above, may provide context for any position in the input sequence. For example, if the input data is a natural language sentence, the transformer does not have to process one word at a time. In some embodiments, multi-head attention may allow different attention heads to emphasize different sources, including user input, processing outputs 184 that summarize image-derived features, and external data 172 retrieved from external data sources 192. In multi-head attention, computations by an LLM may be repeated over several iterations, each computation may form parallel layers known as attention heads. Each separate head may independently pass the input sequence and corresponding output sequence element through a separate head. A final attention score may be produced by combining attention scores at each head so that every nuance of the input sequence is taken into consideration. In additive attention (Bahdanau attention mechanism), an LLM may make use of attention alignment scores based on a number of factors. Alignment scores may be calculated at different points in a neural network, and/or at different stages represented by discrete neural networks. Source or input sequence words are correlated with target or output sequence words but not to an exact degree. This correlation may take into account all hidden states and the final alignment score is the summation of the matrix of alignment scores. In global attention (Luong mechanism), in situations where neural machine translations are required, an LLM may either attend to all source words or predict the target sentence, thereby attending to a smaller subset of words.

With continued reference to FIG. 1B, multi-headed attention in encoder may apply a specific attention mechanism called self-attention. Self-attention allows models such as an LLM or components thereof to associate each word in the input to other words. As a non-limiting example, an LLM may learn to associate the word “you,” with “how” and “are.” It is possible that an LLM learns that words structured in this pattern are typically a question and to respond appropriately. As a further non-limiting example, an LLM may learn to associate query terms in user input with terms commonly occurring in retrieved external data 172 or in structured summaries of processing outputs 184, thereby improving the likelihood that generated natural language outputs 180 remain consistent with image-derived findings. In some embodiments, to achieve self-attention, input may be fed into three distinct fully connected neural network layers to create query, key, and value vectors. A query vector may include an entity's learned representation for comparison to determine attention score. A key vector may include an entity's learned representation for determining the entity's relevance and attention weight. A value vector may include data used to generate output representations. Query, key, and value vectors may be fed through a linear layer; then, the query and key vectors may be multiplied using dot product matrix multiplication in order to produce a score matrix. The score matrix may determine the amount of focus for a word should be put on other words (thus, each word may be a score that corresponds to other words in the time-step). The values in score matrix may be scaled down. As a non-limiting example, score matrix may be divided by the square root of the dimension of the query and key vectors. In some embodiments, the softmax of the scaled scores in score matrix may be taken. The output of this softmax function may be called the attention weights. Attention weights may be multiplied by your value vector to obtain an output vector. The output vector may then be fed through a final linear layer.

With continued reference to FIG. 1B, in some embodiments, processor 108 may incorporate retrieval augmented generation (RAG) into LLM. For the purposes of this disclosure, “retrieval-augmented generation” is a method that enhances a response generation capability of a large language model by integrating external, relevant information retrieved from a structured database or unstructured corpus. In some embodiments, by leveraging RAG, LLM can reduce a risk of generating incorrect or hallucinated information, instead relying on curated and contextually relevant data. For the purposes of this disclosure, “hallucination” of information refers to where a language model fabricates plausible-sounding but incorrect information. In some embodiments, processor 108 may retrieve relevant information as a function of a user query associated with image data 120, including retrieving external data 172 from external data sources 192 that include electronic health records, radiology systems, laboratory systems, pathology report repositories, and public medical resources, and the retrieved data may be input into LLM to generate responses grounded in authoritative sources for display in the activity window. In some embodiments, processor 108 may identify keywords or semantic elements in the query and use these elements to search a database for information, including restricting the retrieval scope based on a selected region of interest in image data 120 or based on processing outputs 184 associated with that region.

With continued reference to FIG. 1B, in some embodiments, processor 108 may utilize similarity-based fetching techniques to identify most relevant data for input to LLM. For the purposes of this disclosure, “similarity-based fetching” is a process by which a query is converted into a high-dimensional vector embedding, representing its semantic meaning, and compared with pre-computed embeddings of documents or data in a database. In some embodiments, retrieved documents with high similarity scores may be integrated into an input for LLM. In some embodiments, processor 108 may select an appropriate database for a given query based on context and sensitivity of information. For instance, and without limitation, queries containing identifiable patient information may restrict retrieval to private internal sources, such as an EHR system, while general medical queries may access public medical databases. In some embodiments, LLM may generate an initial response based on an input query associated with image data 120, and this response may be then analyzed to identify additional relevant keywords or concepts, including terms corresponding to anatomical structures, pathological features, or related clinical findings. In some embodiments, these elements may subsequently be used to perform a second round of data retrieval. In a non-limiting example, additional retrieved data may then be input into LLM alongside the original query and first response to generate an output.

With continued reference to FIG. 1B, in some embodiments, processor 108 may generate hypothetical document embeddings. For the purposes of this disclosure, a “hypothetical document embedding” refers to an embedding created by LLM that represents its semantic understanding of a query or preliminary response. In some embodiments, the embeddings may be compared against database embeddings to identify documents or data closely aligned with the system's understanding of a query. In some embodiments, the retrieved information may then be incorporated into an input of LLM, including retrieved external data 172 associated with a patient record, a clinical report, or published medical references relevant to image data 120.

With continued reference to FIG. 1B, an LLM may receive an input. Input may include a string of one or more characters. Inputs may additionally include unstructured data. For example, input may include one or more words, a sentence, a paragraph, a thought, a query, and the like. A “query” for the purposes of the disclosure is a string of characters that poses a question. In some embodiments, input may be received from a user device. User device may be any computing device that is used by a user. As non-limiting examples, user device may include desktops, laptops, smartphones, tablets, and the like. In some embodiments, input may include any set of data associated with image data 120, including a query entered through a search interface and associated with a selected region of interest displayed in a primary window.

With continued reference to FIG. 1B, an LLM may generate at least one annotation as an output. At least one annotation may be any annotation as described herein. In some embodiments, an LLM may include multiple sets of transformer architecture as described above. Output may include a textual output. A “textual output,” for the purposes of this disclosure is an output comprising a string of one or more characters. Textual output may include, for example, a plurality of annotations for unstructured data. In some embodiments, textual output may include a phrase or sentence identifying the status of a user query. In some embodiments, textual output may include a sentence or plurality of sentences describing a response to a user query. As a non-limiting example, this may include restrictions, timing, advice, dangers, benefits, and the like, including explanations generated for display in the activity window and grounded in external data 172 and processing outputs 184 associated with image data 120.

With continued reference to FIG. 1B, in some embodiments, one or more AI agents 168 include one or more deterministic agents 190. For the purposes of this disclosure, “deterministic agents” are AI agents configured to perform decision-making operations. In some embodiments, deterministic agents 190 may perform such decision-making operations using rule-based logic, algorithmically defined evaluation procedures, threshold-based decision models, decision trees, scoring functions, or other deterministic analytical models whose behavior is fully specified by predefined criteria stored in memory. In some embodiments, deterministic agents 190 may operate on at least one of user input 164, image data 120, processing outputs 184 generated by one or more image processing agents 186, and external data 172 retrieved from one or more external data sources 192 to determine one or more conclusions, classifications, or responses associated with the image data 120. In some embodiments, deterministic agents 190 may be configured to evaluate image-derived features represented in processing outputs 184 against predefined decision criteria to generate determinations related to anatomical structures, pathological conditions, or image quality attributes. As a non-limiting example, a deterministic agent 190 may evaluate segmentation outputs, feature measurements, or region-of-interest characteristics to determine whether a selected region of image data 120 exhibits a deformation, abnormality, disease state, or other clinically relevant condition. As another non-limiting example, a deterministic agent 190 may evaluate user input 164 that includes a question or query and generate a direct, rule-based answer based on predefined mappings between query types and evaluation logic applied to image data 120 or external data 172. In some embodiments, deterministic agents 190 may generate deterministic outputs 188. For the purposes of this disclosure, “deterministic outputs” are determinations or decisions produced by deterministic agents based on predefined evaluation criteria and deterministic processing logic. In some embodiments, deterministic outputs 188 may include, for example and without limitation, an answer to a question included in the user input 164, a binary or multi-class determination indicating presence or absence of a condition, a classification of tissue type or pathological feature, an identification of an anatomical structure present within image data 120, a determination of whether image data 120 satisfies one or more diagnostic, analytical, or quality criteria, or a selection of a region of interest for further analysis. In some embodiments, deterministic agents 190 may also perform operational control functions within the agentic framework. As a non-limiting example, a deterministic agent 190 may determine whether sufficient evidence exists to trigger retrieval of additional external data 172, whether additional image processing operations should be executed, whether a region of interest should be expanded or refined, or whether a follow-up query should be issued to one or more external data sources 192. In some embodiments, such determinations may be used to control execution flow among multiple AI agents 168. In some embodiments, deterministic outputs 188 may be provided as inputs to one or more LLM agents 182. In some embodiments, LLM agents 182 may use deterministic outputs 188 as constraints, grounding signals, or authoritative determinations when generating natural language outputs 180. As a non-limiting example, a deterministic output 188 indicating a specific anatomical classification or pathological finding may be supplied to an LLM agent 182, which may then generate a natural language output 180 explaining the determination, providing context from external data 172, or elaborating on clinical implications for presentation within the activity window 156.

With continued reference to FIG. 1B, in some embodiments, such determinations may be used to control execution flow among multiple AI agents 168. In some embodiments, deterministic outputs 188 generated by deterministic agents 190 may be used as control signals, gating parameters, or execution conditions that govern whether, when, and how one or more other AI agents 168 are executed. For example, and without limitation, a deterministic output 188 may indicate that a condition associated with image data 120 has been satisfied, unmet, or indeterminate, and processor 108 may use that indication to trigger execution of one or more LLM agents 182, suppress execution of one or more image processing agents 186, or block retrieval of external data 172 from one or more external data sources 192. In some embodiments, deterministic outputs 188 may function as Boolean flags, threshold-based indicators, categorical classifications, or confidence-scored determinations that are evaluated by processor 108 prior to invoking additional agent operations. For example, and without limitation, a deterministic output 188 indicating that a selected region of interest of image data 120 satisfies predefined quality, relevance, or diagnostic criteria may cause processor 108 to enable execution of an LLM agent 182 to generate explanatory natural language outputs 180, whereas a deterministic output 188 indicating insufficient image quality, ambiguity, or failure to meet predefined constraints may cause processor 108 to defer, limit, or suppress execution of the LLM agent 182.

With continued reference to FIG. 1B, in some embodiments, deterministic outputs 188 may be used to select among multiple execution pathways for AI agents 168. For example, and without limitation, a deterministic agent 190 may classify user input 164 as requesting factual identification, diagnostic assessment, or exploratory analysis, and processor 108 may route execution accordingly, such that an image processing agent 186 is executed prior to an LLM agent 182 for factual determinations, or an LLM agent 182 is executed directly when deterministic outputs 188 indicate that sufficient processing outputs 184 are already available. In some embodiments, deterministic outputs 188 may further control which external data 172 are retrieved, including restricting retrieval to specific external data sources 192 or preventing retrieval entirely based on privacy, confidence, or relevance constraints. In some embodiments, deterministic outputs 188 may be used to terminate, pause, or modify ongoing agent execution. For example, and without limitation, if a deterministic output 188 generated during execution indicates that subsequent agent processing would be redundant, inconsistent, or outside a permitted scope, processor 108 may halt execution of one or more AI agents 168 or adjust execution parameters such as model selection, prompt construction, or retrieval scope. In this manner, deterministic agents 190 may provide a supervisory or orchestration function that ensures controlled, repeatable, and constrained interaction among multiple AI agents 168 within the activity window 156.

With continued reference to FIG. 1B, executing AI agents 168 includes retrieving external data 172 from external data sources 192. For the purposes of this disclosure, “external data sources” are systems or repositories external to system 100b that store information. For the purposes of this disclosure, “external data” is information retrieved from one or more external data sources for use in generating one or more agent outputs 176 associated with image data 120. In some embodiments, external data 172 may include structured data, semi-structured data, or unstructured data. For example, and without limitation, external data 172 may include clinical documents, pathology reports, radiology reports, laboratory test results, medication lists, procedure histories, diagnostic codes, order data, clinical guidelines, peer-reviewed biomedical literature, imaging metadata, genomic or molecular assay results, or longitudinal patient history information. In some embodiments, external data sources 192 may include electronic health record systems, radiology systems, laboratory systems, pathology databases, biomedical literature repositories, clinical decision support systems, hospital information systems, picture archiving and communication systems (PACS), laboratory information systems (LIS), radiology information systems (RIS), genomics repositories, or other institutional or public repositories configured to store medical or scientific information. In some embodiments, external data sources 192 may include one or more databases storing structured tables, one or more document stores storing unstructured records, and/or one or more application programming interfaces (APIs) enabling programmatic access to the stored information.

With continued reference to FIG. 1B, in some embodiments, AI agents 168 may retrieve external data 172 by executing one or more query operations against external data sources 192. In some embodiments, retrieving external data 172 may include normalizing user input 164 using an LLM agent 182 and executing one or more query operations against the external data sources 192 using the normalized user input. For the purposes of this disclosure, “normalized user input” is a transformed representation of user input 164 that has been processed to produce a structured, machine-interpretable form suitable for automated querying and reasoning. Normalized user input may include one or more extracted semantic elements derived from the original user input, including identified entities, keywords, concepts, constraints, and relationships. Normalized user input may exclude presentation-specific or syntactic variability present in the original user input. Normalized user input may be generated by applying one or more preprocessing operations to user input 164, including tokenization, entity recognition, semantic parsing, synonym resolution, disambiguation, and mapping of free-text expressions to standardized terms or identifiers. For the purposes of this disclosure, a “query operation” is a computational operation executed to retrieve data from one or more data sources. A query operation may include forming a query representation compatible with a target external data source and executing the query to obtain one or more candidate data items. Query operations may include structured database queries, keyword-based searches, semantic searches using vector embeddings, similarity-based retrieval operations, application programming interface (API) requests, and combinations thereof, and produce external data 172 for use in generating one or more agent outputs 176. In some embodiments, normalizing user input 164 may include extracting one or more query entities, clinical terms, anatomical references, temporal constraints, or identifiers from the user input 164 and generating one or more query representations configured to be compatible with at least one external data source. In some embodiments, executing one or more query operations may include submitting one or more structured queries, keyword searches, semantic searches, embedding-based similarity searches, or combinations thereof to retrieve candidate data items responsive to the user input 164 and associated with image data 120.

With continued reference to FIG. 1B, in some embodiments, retrieving external data 172 may include collecting candidate data items from one or more external data sources 192 as a function of the normalized user input 164, filtering the candidate data items based on relevance conditions associated with at least one of image data 120 and user input 164, and generating a synthesized representation of the filtered candidate data items. For the purposes of this disclosure, “candidate data items” are discrete units of information retrieved from one or more external data sources 192 in response to a query operation and prior to relevance-based filtering. Candidate data items may include individual records, documents, document fragments, database rows, report sections, metadata entries, or other retrievable information elements obtained from external data sources 192 that are potentially responsive to the normalized user input 164. In some embodiments, candidate data items may include clinical notes, pathology reports, radiology reports, laboratory results, imaging metadata, guideline excerpts, literature abstracts, patient-specific records, or portions thereof retrieved from one or more external data sources 192 based on the normalized user input 164. For the purposes of this disclosure, “relevance conditions” are evaluation conditions used to assess suitability of candidate data items for use in generating agent outputs 176. Relevance conditions may define how candidate data items are compared, scored, included, or excluded based on their relationship to image data 120, user input 164, or processing outputs 184. In some embodiments, relevance conditions may include alignment to a selected region of interest in image data 120, correspondence to a tissue type or anatomical feature identified in processing outputs 184, recency constraints, source reliability constraints, patient-identifier matching constraints, specialty-specific constraints, confidence thresholds, or consistency constraints relative to previously generated agent outputs 176. In some embodiments, relevance conditions may be applied deterministically, probabilistically, or using a combination of rule-based evaluation and model-assisted scoring. For the purposes of this disclosure, a “synthesized representation” is an aggregation of filtered candidate data items produced to support reasoning, explanation, or output generation by one or more AI agents 168. A synthesized representation may consolidate information from multiple candidate data items into a form suitable for downstream processing. In some embodiments, the synthesized representation may include a ranked subset of candidate data items, an extractive summary of key passages, a structured set of normalized fields, a temporally ordered aggregation, or a consolidated evidentiary context linking external data 172 to image data 120 and processing outputs 184. In some embodiments, the synthesized representation may be provided as an input to one or more deterministic agents 190 or LLM agents 182 for use in generating one or more agent outputs 176 for presentation within the activity window.

With continued reference to FIG. 1B, in some embodiments, processor 108 may be configured to filter the candidate data items based on relevance conditions associated with at least one of image data 120 and user input 164 and to generate a synthesized representation of the filtered candidate data items. In some embodiments, processor 108 may evaluate each candidate data item by applying one or more relevance conditions to attributes of the candidate data item, including textual content, metadata, temporal attributes, source identifiers, and semantic similarity measures relative to the normalized user input 164 and features derived from image data 120. In some embodiments, relevance conditions may be applied by computing relevance scores that quantify alignment between candidate data items and one or more selected regions of interest in image data 120, tissue types or anatomical features identified in processing outputs 184, or concepts extracted from user input 164. In some embodiments, processor 108 may exclude candidate data items that fail to satisfy one or more relevance thresholds and may retain candidate data items that satisfy the relevance conditions. In some embodiments, processor 108 may aggregate the retained candidate data items by ranking, clustering, summarizing, or normalizing the retained data items to generate a synthesized representation that consolidates information from multiple sources into a coherent structure. In some embodiments, the synthesized representation may be generated as a structured data object, a ranked list, an extractive summary, or a normalized evidentiary context that is configured for use as an input to one or more AI agents 168 in generating one or more agent outputs 176 for presentation within the activity window.

With continued reference to FIG. 1B, processor 108 updates display data structure 148 as a function of agent outputs 176. Updating the display data structure 148 includes updating the at least an activity window 156 as a function of the one or more agent outputs 176. In some cases, updating the activity window 156 may include identifying and extracting a region of interest from image data 120 using image processing agents 186. In some cases, updating the activity window 156 may further include modifying a presentation state of the activity window 156 as a function of the region of interest. In some cases, modifying the presentation state may include spatially aligning derived content in the activity window 156 with a corresponding spatial location of the region of interest in image data 120 using coordinate mappings and registration parameters. For the purposes of this disclosure, a “region of interest” is a defined subset of image data 120 corresponding to a spatially localized portion of the image that is identified for focused analysis, visualization, or interaction. A region of interest may be represented by one or more spatial parameters defining its location and extent within image data 120, including pixel coordinates, bounding geometries, masks, contours, or combinations thereof. In some cases, user input 164 may include region of interest. For the purposes of this disclosure, a “presentation state” is a set of display attributes governing how content is visually rendered within a window of the user interface 194. In some cases, presentation state may include spatial position, scale, alignment, visibility, layering, emphasis, and synchronization behavior relative to other displayed content.

With continued reference to FIG. 1B, in some embodiments, updating the activity window 156 may include identifying and extracting a region of interest from image data 120 using one or more image processing agents 186. In some embodiments, processor 108 may invoke image processing agents 186 to analyze image data 120 and processing outputs 184 to determine spatial boundaries of a region of interest based on user input 164, detected anatomical structures, pathological features, annotations, segmentation masks, or confidence scores. In some embodiments, identifying the region of interest may include selecting a subset of image data 120 using pixel-level masks, vector contours, bounding boxes, or region labels produced by image processing agents 186, and extracting corresponding spatial parameters for downstream use.

With continued reference to FIG. 1B, in some embodiments, updating the activity window 156 may further include modifying a presentation state of the activity window 156 as a function of the region of interest. In some embodiments, processor 108 may modify the presentation state by adjusting visual attributes of derived content displayed within the activity window 156 to reflect spatial characteristics of the region of interest. For example, and without limitation, processor 108 may resize, reposition, zoom, highlight, or otherwise emphasize derived content corresponding to the region of interest, or may suppress or de-emphasize derived content unrelated to the region of interest. In some embodiments, modifying the presentation state may include spatially aligning derived content in the activity window 156 with a corresponding spatial location of the region of interest in image data 120 using coordinate mappings and registration parameters. In some embodiments, processor 108 may compute or retrieve coordinate transformations that map coordinates of the region of interest in image data 120 to coordinates within the activity window 156. Such transformations may include scaling factors, translation vectors, rotation parameters, affine transformations, homography matrices, or other registration parameters derived from image metadata, viewing parameters, or prior alignment operations. In some embodiments, processor 108 may apply the coordinate mappings to anchor textual, graphical, or symbolic derived content within the activity window 156 at positions that correspond to the spatial location of the region of interest in image data 120, thereby maintaining visual coherence and contextual alignment between the activity window 156 and the primary window displaying image data 120. In some embodiments, processor 108 may dynamically update the presentation state in response to changes in the region of interest, including panning, zooming, or selection of a different region by the user. In some embodiments, such updates may be performed in real time or near real time to preserve spatial correspondence between image data 120 and derived content presented within the activity window 156 as the user interacts with the display data structure 148.

With continued reference to FIG. 1B, in some embodiments, updating the display data structure 148 may include updating the at least a primary window 152 as a function of the user interaction with the one or more interactive elements 196, wherein the user interaction may include selecting the one or more interactive elements 196 to modify a presentation state of the at least a primary window 152 within the display data structure 148. In some cases, user interaction may include selecting, activating, or manipulating the one or more interactive elements 196 to modify a presentation state of the at least a primary window 152 within the display data structure 148. In some embodiments, the presentation state of the primary window 152 may define how image data 120 is visually rendered, including one or more of zoom level, magnification, pan position, orientation, layering, opacity, resolution, or visibility relative to other windows. In some embodiments, processor 108 may modify the presentation state of the primary window 152 in response to user interaction by dynamically resizing the primary window 152, repositioning the primary window 152 within the display data structure 148, minimizing or expanding the primary window 152, or transitioning the primary window 152 between foreground and background display layers. In some embodiments, user interaction with the one or more interactive elements 196 may include selecting controls that alter how image data 120 is presented for analytical review, such as toggling between different magnification levels, switching between overview and detailed views, enabling or disabling overlays, or synchronizing the primary window 152 with the at least an activity window 156. In some embodiments, processor 108 may update the presentation state of the primary window 152 to reflect context provided by agent outputs 176, such as automatically centering the primary window 152 on a region of interest identified by one or more AI agents 168 or adjusting magnification to correspond to a spatial scale relevant to derived content displayed in the activity window 156. In some embodiments, such updates may be performed continuously or in response to discrete user actions to support fluid navigation, comparative analysis, and coordinated visualization between the primary window 152 and the activity window 156.

With continued reference to FIG. 1B, apparatus and/or circuitry may, in some embodiments, use a client-side program to configure a user device to display data and to perform event handling of user inputs associated with a user interface 194, wherein such display is implemented, without limitation, as a graphical user interface rendering a display data structure comprising at least an activity window and one or more interactive elements 196. In some embodiments, apparatus and/or circuitry configures the user device to display outputs generated by one or more AI agents 168 within the activity window, including agent outputs 176 derived from image data, external data 172, and user input, and further to display intermediate outputs associated with execution of the AI agents 168, such as normalized queries, candidate data items, deterministic outputs 188, processing outputs 184, and natural language outputs 180. In some embodiments, apparatus and/or circuitry configures the user device to display one or more event handler graphics associated with the interactive elements 196, wherein an event handler graphic is a graphical element with which a user interacts to provide user input, including, for example and without limitation, a search query associated with image data, a selection of a region of interest, or a selection of an option that modifies a presentation state of a primary window 152 or an activity window 156. Event handler graphics may include, without limitation, buttons, links, checkboxes, text entry boxes or windows, drop-down lists, sliders, or other interface controls configured to initiate execution of one or more AI agents 168. In some embodiments, an event handler is a module, data structure, function, and/or routine executed by apparatus and/or circuitry in response to user interaction with an event handler graphic, wherein the event handler records user input data, validates user input data, formats user input data into a representation suitable for processing by one or more AI agents 168, and transmits the user input data to apparatus and/or circuitry for use in retrieving external data 172 and generating agent outputs 176. In some embodiments, the event handler generates prompts for additional information, enforces validation rules associated with search queries or image-related inputs, modifies user input data into a normalized form, and initiates execution of one or more deterministic agents 190 or LLM agents 182 in response to the user interaction.

With continued reference to FIG. 1B, in some embodiments, an event handler includes a cross-session state variable associated with the user interface 194. As used herein, a “cross-session state variable” is a variable that records data entered on a user device during a prior user session and that persists across multiple sessions of interaction with the apparatus and/or circuitry. In some embodiments, the cross-session state variable includes one or more prior session data items, including, for example and without limitation, previously entered search queries, prior selections of regions of interest within image data, prior interactive element selections, or prior filters applied to external data 172. In some embodiments, cross-session state variable data is stored using a combination of client-side storage on the user device and server-side storage on apparatus and/or circuitry, including storage as cookies, session identifiers, or persistent user profiles. In some embodiments, apparatus and/or circuitry retrieves the cross-session state variable using login credentials, device identifiers, or device fingerprint data and transmits the cross-session state variable to the user device for use in configuring the user interface 194. In some embodiments, an event handler graphic is configured to display at least a portion of the cross-session state variable, including auto-populating a search interface with a previously entered query or reapplying prior query parameters, thereby enabling iterative, search-driven interaction with image data and external data 172 in accordance with execution of the one or more AI agents 168.

With continued reference to FIG. 1B, the present disclosure may provide a technical solution to one or more technical problems associated with integrating complex image data analysis, heterogeneous external data retrieval, and AI-assisted reasoning within an interactive visualization environment. In some embodiments, existing systems may suffer from rigid display architectures, fragmented analytical workflows, or non-deterministic agent behavior that limits traceability, reproducibility, and user trust in generated outputs. The system may address these limitations by providing a coordinated, processor-driven architecture in which deterministic agents, image processing agents, and LLM agents operate in a controlled and interoperable manner over shared data representations. In some cases, the processor may orchestrate execution of AI agents such that deterministic agents perform rule-based or algorithmically defined decision-making on image data and user input, thereby generating stable and repeatable determinations that can be used to gate, trigger, suppress, or parameterize downstream execution of probabilistic or generative agents. In some embodiments, this layered agent architecture may reduce computational inefficiencies and prevent unnecessary invocation of resource-intensive models while preserving analytical rigor. Additionally, by updating a display data structure as a function of agent outputs and user interaction, the system may provide a dynamic yet technically grounded mechanism for aligning derived content, external data, and analytical conclusions with spatial regions of image data in real time. In this way, the disclosure may solve a technical problem of synchronizing multimodal AI processing with interactive visualization by introducing a structured execution flow, deterministic control points, and presentation-state-aware rendering, thereby improving system reliability, scalability, and usability in image-centric analytical applications.

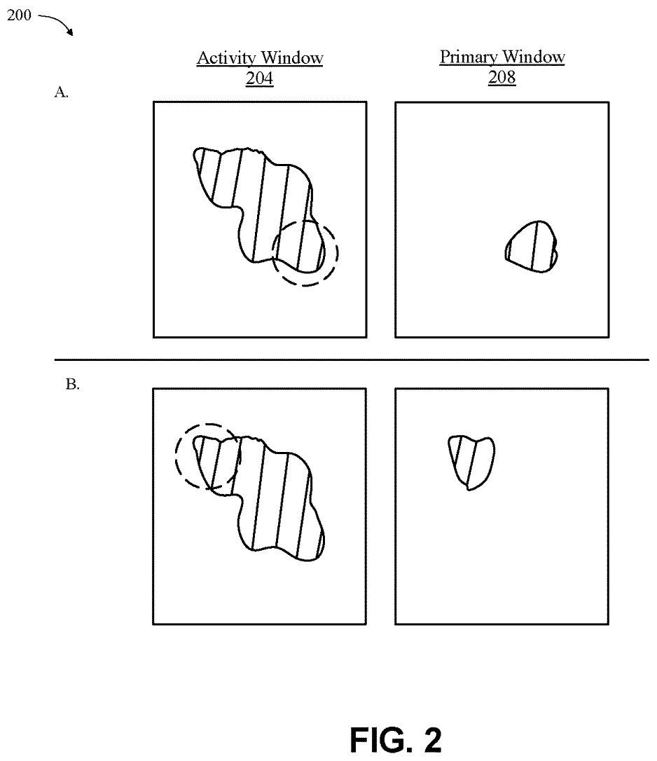

Now referring to FIG. 2, illustrated is a particular implementation 200 of a system for augmented visualization using activity windows, wherein a user may highlight a portion of the image data. In an embodiment, a user may highlight a certain portion of the image data within activity window 204. The highlighted portion of image data, or the highlighted subset of the image data is displayed in primary window 208. The subset image data displayed in primary window 208 may be zoomed in and out based on the resolution levels available to the image data. Panel set A, illustrates the bottom right portion of the image data being highlighted in activity window 204. The corresponding subset image is displayed in primary window 208. Likewise, panel set B illustrates the top left portion of image data being highlighted in activity window 204. The corresponding subset image data is displayed in primary window 208.

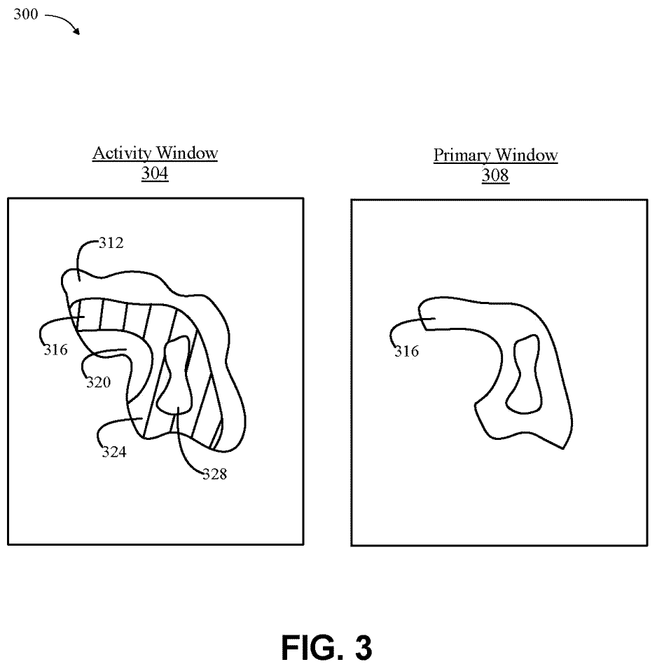

Now referring to FIG. 3, illustrated is a particular implementation 300 of a system for augmented visualization using activity windows, wherein a user may select a segment of image data to view. Selection of a segment from activity window 304 will display only the image data contents of that segment in primary window 308. Illustrated in activity window 304, is image data being segmented into five parts: 312, 316, 320, 324, and 328. Part 316 was selected by the user in activity window 304. Therefore, only part 316 is displayed in primary window 308. Pan, zoom, and/or other user interface options are available for part in primary window 308.

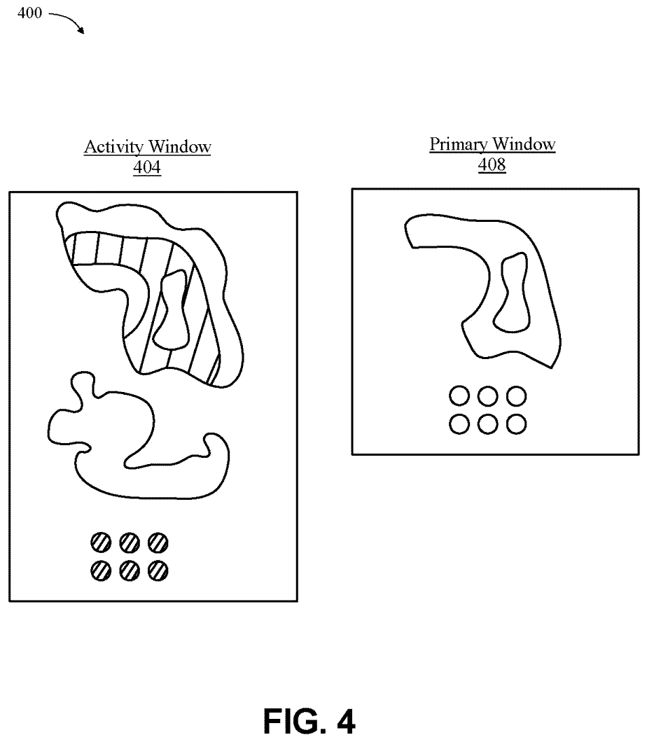

Now referring to FIG. 4, illustrated is a particular implementation 400 of a system for augmented visualization using activity windows, wherein selected segments from the activity window 404 are shown. A user may select segments from image data from different locations of the image data, as shown in FIG. 4. The segments may be spatially reorganized as a virtual slide in primary window 408 in a compact representation of segments for ease of analysis.

Now referring to FIG. 5, illustrated is a particular implementation 500 of a system for augmented visualization using activity windows, wherein selected segments from multiple activity windows are shown. In some embodiments a user may select segments of image data from one or more activity windows, such as activity window 504 and activity window 508, having one or more image data present. The segments may be spatially reorganized as a virtual slide in primary window 512 in a compact representation of segments of interest for ease of analysis. Pan, zoom, and/or other user interface options as discussed throughout this disclosure are available for the selected segments displayed in primary window 512.

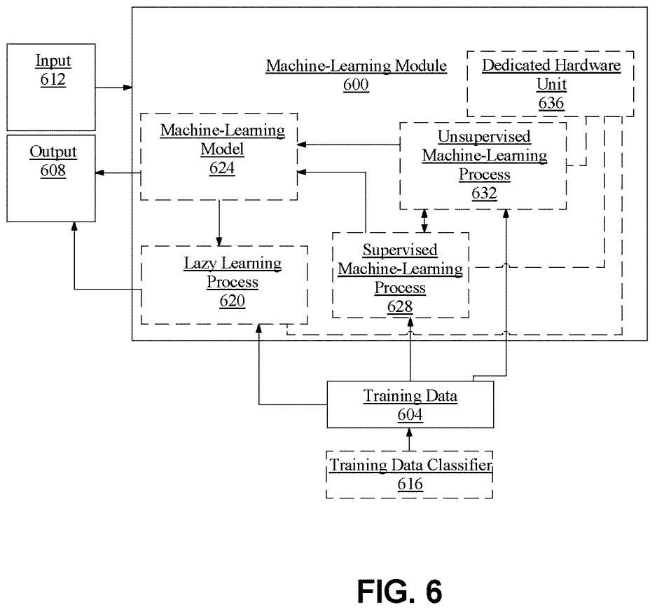

Referring now to FIG. 6, an exemplary embodiment of a machine-learning module 600 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 604 to generate an algorithm instantiated in hardware or software logic, data structures, and/or functions that will be performed by a computing device/module to produce outputs 608 given data provided as inputs 612; this is in contrast to a non-machine learning software program where the commands to be executed are determined in advance by a user and written in a programming language.

Still referring to FIG. 6, “training data,” as used herein, is data containing correlations that a machine-learning process may use to model relationships between two or more categories of data elements. For instance, and without limitation, training data 604 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 604 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 604 according to various correlations; correlations may indicate causative and/or predictive links between categories of data elements, which may be modeled as relationships such as mathematical relationships by machine-learning processes as described in further detail below. Training data 604 may be formatted and/or organized by categories of data elements, for instance by associating data elements with one or more descriptors corresponding to categories of data elements. As a non-limiting example, training data 604 may include data entered in standardized forms by persons or processes, such that entry of a given data element in a given field in a form may be mapped to one or more descriptors of categories. Elements in training data 604 may be linked to descriptors of categories by tags, tokens, or other data elements; for instance, and without limitation, training data 604 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 6, training data 604 may include one or more elements that are not categorized; that is, training data 604 may not be formatted or contain descriptors for some elements of data. Machine-learning algorithms and/or other processes may sort training data 604 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 604 to be made applicable for two or more distinct machine-learning algorithms as described in further detail below. Training data 604 used by machine-learning module 600 may correlate any input data as described in this disclosure to any output data as described in this disclosure.

Further referring to FIG. 6, training data may be filtered, sorted, and/or selected using one or more supervised and/or unsupervised machine-learning processes and/or models as described in further detail below; such models may include without limitation a training data classifier 616. Training data classifier 616 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 600 may generate a classifier using a classification algorithm, defined as a processes whereby a computing device and/or any module and/or component operating thereon derives a classifier from training data 604. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

Still referring to FIG. 6, Computing device may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)=P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device may then calculate a likelihood table by calculating probabilities of different data entries and classification labels. Computing device may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 6, Computing device may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 6, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm:

$$l = \sqrt{{\sum }_{i = 0}^{n} {a}_{i}^{2}} ,$$

where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 6, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Continuing to refer to FIG. 6, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

Still referring to FIG. 6, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

As a non-limiting example, and with further reference to FIG. 6, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 6, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 6, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Further referring to FIG. 6, feature selection includes narrowing and/or filtering training data to exclude features and/or elements, or training data including such elements, that are not relevant to a purpose for which a trained machine-learning model and/or algorithm is being trained, and/or collection of features and/or elements, or training data including such elements, on the basis of relevance or utility for an intended task or purpose for a trained machine-learning model and/or algorithm is being trained. Feature selection may be implemented, without limitation, using any process described in this disclosure, including without limitation using training data classifiers, exclusion of outliers, or the like.

With continued reference to FIG. 6, feature scaling may include, without limitation, normalization of data entries, which may be accomplished by dividing numerical fields by norms thereof, for instance as performed for vector normalization. Feature scaling may include absolute maximum scaling, wherein each quantitative datum is divided by the maximum absolute value of all quantitative data of a set or subset of quantitative data. Feature scaling may include min-max scaling, in which each value X has a minimum value Xₘᵢₙ in a set or subset of values subtracted therefrom, with the result divided by the range of the values, give maximum value in the set or subset Xₘₐₓ:

$${X}_{n e w} = \frac{X - {X}_{min}}{{X}_{max} - {X}_{min}} .$$

Feature scaling may include mean normalization, which involves use of a mean value of a set and/or subset of values, Xₘₑₐₙ with maximum and minimum values:

$${X}_{n e w} = \frac{X - {X}_{m e a n}}{{X}_{max} - {X}_{min}} .$$

Feature scaling may include standardization, where a difference between X and Xₘₑₐₙ is divided by a standard deviation σ of a set or subset of values:

$${X}_{n e w} = \frac{X - {X}_{m e a n}}{σ} .$$

Scaling may be performed using a median value of a set or subset X_{median} and/or interquartile range (IQR), which represents the difference between the 25^{th} percentile value and the 50^{th} percentile value (or closest values thereto by a rounding protocol), such as:

$${X}_{n e w} = \frac{X - {X}_{m e d i a n}}{IQR} .$$

Persons skilled in the art, upon reviewing the entirety of this disclosure, will be aware of various alternative or additional approaches that may be used for feature scaling.

Further referring to FIG. 6, computing device, processor, and/or module may be configured to perform one or more processes of data augmentation. “Data augmentation” as used in this disclosure is addition of data to a training set using elements and/or entries already in the dataset. Data augmentation may be accomplished, without limitation, using interpolation, generation of modified copies of existing entries and/or examples, and/or one or more generative AI processes, for instance using deep neural networks and/or generative adversarial networks; generative processes may be referred to alternatively in this context as “data synthesis” and as creating “synthetic data.” Augmentation may include performing one or more transformations on data, such as geometric, color space, affine, brightness, cropping, and/or contrast transformations of images.

Still referring to FIG. 6, machine-learning module 600 may be configured to perform a lazy-learning process 620 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 604. Heuristic may include selecting some number of highest-ranking associations and/or training data 604 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 6, machine-learning processes as described in this disclosure may be used to generate machine-learning models 624. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 624 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 624 may be generated by creating an artificial neural network, such as a convolutional neural network comprising an input layer of nodes, one or more intermediate layers, and an output layer of nodes. Connections between nodes may be created via the process of “training” the network, in which elements from a training data 604 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 6, machine-learning algorithms may include at least a supervised machine-learning process 628. At least a supervised machine-learning process 628, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include input as described above or through incorporation as inputs, outputs as described above or through incorporation as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 604. Persons skilled in the art, upon reviewing the entirety of this disclosure, will be aware of various possible variations of at least a supervised machine-learning process 628 that may be used to determine relation between inputs and outputs. Supervised machine-learning processes may include classification algorithms as defined above.

With further reference to FIG. 6, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 6, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 6, machine learning processes may include at least an unsupervised machine-learning processes 632. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 632 may not require a response variable; unsupervised processes 632 may be used to find interesting patterns and/or inferences between variables, to determine a degree of correlation between two or more variables, or the like.

Still referring to FIG. 6, machine-learning module 600 may be designed and configured to create a machine-learning model 624 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 6, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 6, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 6, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 6, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 6, one or more processes or algorithms described above may be performed by at least a dedicated hardware unit 636. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 636 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 636 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 636 to perform one or more operations described herein, such as evaluation of model and/or algorithm outputs, one-time or iterative updates to parameters, coefficients, weights, and/or biases, and/or any other operations such as vector and/or matrix operations as described in this disclosure.

Referring now to FIG. 7, an exemplary embodiment of neural network 700 is illustrated. A neural network 700 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 704, one or more intermediate layers 708, and an output layer of nodes 712. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

Referring now to FIG. 8, an exemplary embodiment of a node 800 of a neural network is illustrated. A node may include, without limitation, a plurality of inputs xi that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tan h (hyperbolic tangent) function, of the form

$$\frac{{e}^{x} - {e}^{- x}}{{e}^{x} + {e}^{- x}} ,$$

a tan h derivative function such as ƒ(x)=tan h²(x), a rectified linear unit function such as ƒ(x)=max(0, x), a “leaky” and/or “parametric” rectified linear unit function such as ƒ(x)=max(ax, x) for some a, an exponential linear units function such as

$$f ( x ) = \{ \begin{matrix}x for x \geq 0 \\ α ( {e}^{x} - 1 ) for x < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as ƒ(x)=x*sigmoid(x), a Gaussian error linear unit function such as f(x)=a(1+tan h(\sqrt{2/π}(x+bx^{r}))) for some values of a, b, and r, and/or a scaled exponential linear unit function such as

$$f ( x ) = λ \{ \begin{matrix}α ( {e}^{x} - 1 ) for x < 0 \\ x for x \geq 0\end{matrix} .$$

Fundamentally, there is no limit to the nature of functions of inputs xi that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function p, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

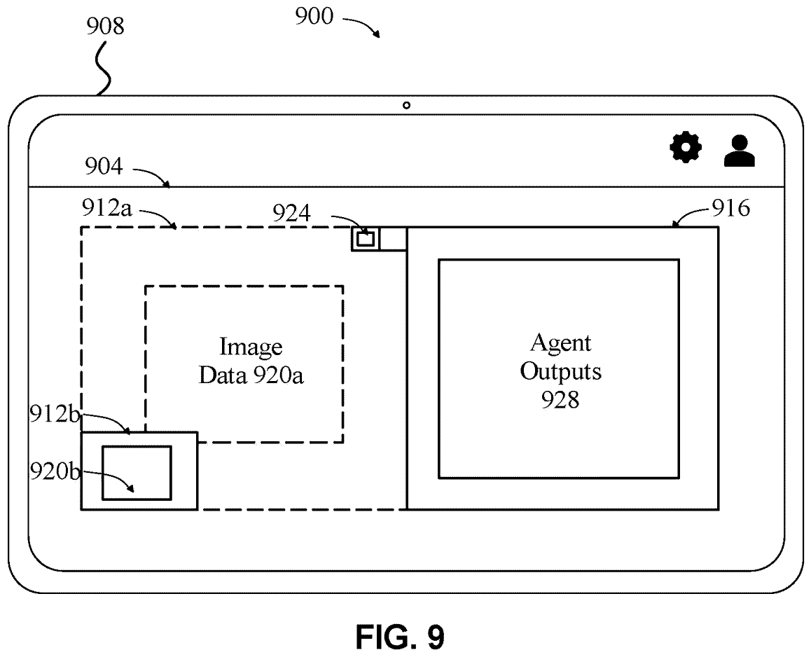

Referring now to FIG. 9, an exemplary user interface 900 is illustrated. In some cases, user interface 900 may be presented using an interactive display device 908 and may include a display data structure 904. In some embodiments, the display data structure 904 may define a layout and visual hierarchy for presenting image-related content and agent-generated information within the user interface 900. The display data structure 904 may include a primary window 912a, which may function as an original or main primary window configured to display image data 920a at an initial size, resolution, or level of prominence. In some cases, the image data 920a displayed within the primary window 912a may represent a full-resolution view, a selected region of interest, or a default presentation of underlying image data. In some embodiments, the display data structure 904 may further include one or more interactive elements 924 associated with the primary window 912a, wherein selection of an interactive element 924 by a user may trigger a modification of a presentation state of the primary window 912a. For example, and without limitation, selection of the interactive element 924 may cause the primary window 912a to transition into a modified or minimized presentation state represented by primary window 912b. In such embodiments, the primary window 912b may display image data 920b corresponding to the same underlying image content as image data 920a, but rendered in a reduced size, minimized format, thumbnail view, or secondary presentation state to preserve contextual awareness while freeing display space. In some embodiments, the display data structure 904 may further include an activity window 916 arranged adjacent to the primary window 912a and/or the primary window 912b, wherein the activity window 916 may be configured to present agent outputs 928 generated by one or more AI agents. In some cases, the activity window 916 may remain visible or may be emphasized when the primary window transitions from primary window 912a to primary window 912b, thereby enabling concurrent visualization of image data 920a or image data 920b and the corresponding agent outputs 928 within the user interface 900.

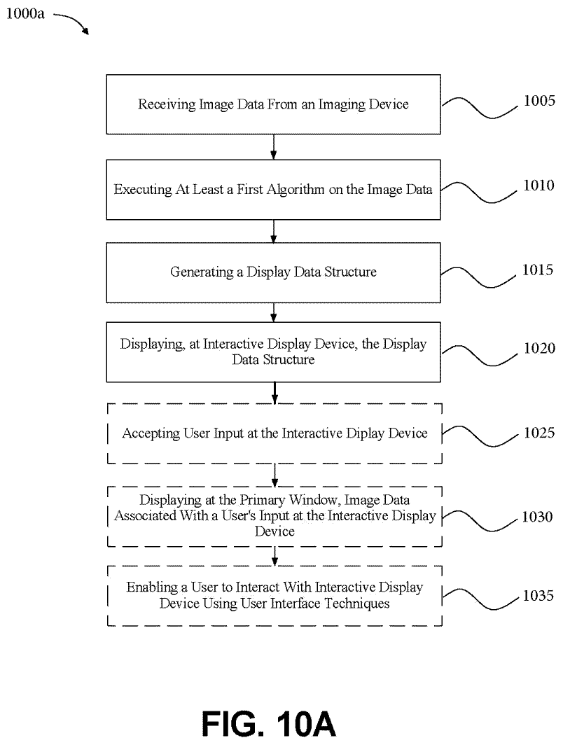

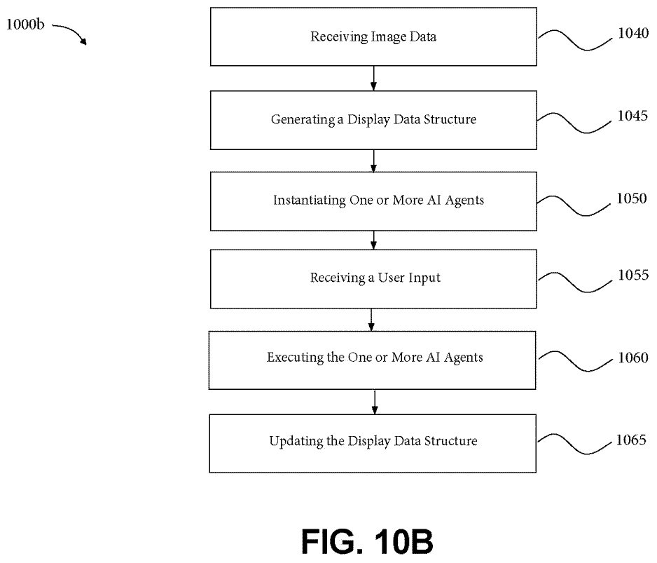

Now referring to FIG. 10A, illustrated is a flow diagram of an exemplary method 1000a of augmented visualization using activity windows. In an embodiment, method 1000a of augmented visualization using activity windows may include receiving image data from an imaging device 1005, executing at least a first algorithm on the image data 1010, generating a display data structure 1015, and displaying, at interactive display device, at the display data structure 1020. Further, in some embodiments method 1000a may include accepting user input at the interactive display device 1025, displaying at primary window, image data associated with a user's input 1030, and enabling a user to interact with interactive display device using pan, zoom, and/or other user interface techniques as described throughout this disclosure 1035. User input may include selecting and/or highlighting a region of interest of image data, selecting one or more segments of interest from image data present in activity window, and/or when indicating more than one segment of interest choosing to display the selected segments in a composite view.

Referring now to FIG. 10B, a flow diagram of an exemplary method 1000b of augmented visualization using activity windows is illustrated. Methods 1000b contains a step 1040 of receiving, using at least a processor, image data. This may be implemented as described and with reference to FIGS. 1-9.

With continued reference to FIG. 10B, method 1000b contains a step 1045 of generating, using at least a processor, a display data structure including at least an activity window configured to display derived content associated with image data. This may be implemented as described and with reference to FIGS. 1-9.

With continued reference to FIG. 10B, method 1000b contains a step 1050 of instantiating, using at least a processor, one or more artificial intelligence (AI) agents within at least an activity window. This may be implemented as described and with reference to FIGS. 1-9.

With continued reference to FIG. 10B, method 1000b contains a step 1055 of receiving, using at least a processor, a user input associated with image data in response to user interaction with a display data structure. In some embodiments, receiving the user input may include receiving the user input using a user input field associated with the one or more interactive elements, wherein the user input field may include a search interface. These may be implemented as described and with reference to FIGS. 1-9.

With continued reference to FIG. 10B, method 1000b contains a step 1060 of executing, using at least a processor, one or more AI agents, wherein executing the one or more AI agents includes retrieving, using the one or more AI agents, external data from one or more external data sources as a function of a user input and generating, using the one or more AI agents, one or more agent outputs as a function of the external data and the image data. In some embodiments, executing the one or more AI agents may include generating, using an image processing agent of the one or more AI agents, one or more processing outputs of the one or more agent outputs as a function of the image data, wherein the one or more processing outputs may include annotation data associated with the image data. In some embodiments, executing the one or more AI agents may include correlating, using a large language model (LLM) agent of the one or more AI agents, the external data, the one or more processing outputs and the image data, and generating, using the LLM agent, one or more natural language outputs of the one or more agent outputs as a function of the correlations among the external data, the one or more processing outputs and the image data. In some embodiments, executing the one or more AI agents may include generating, using a deterministic agent of the one or more AI agents, one or more deterministic outputs of the one or more agent outputs as a function of the image data, the external data and the user input, and generating, using a LLM agent of the one or more AI agents, one or more natural language outputs of the one or more agent outputs as a function of the one or more deterministic outputs. In some embodiments, retrieving the external data may include normalizing, using a LLM agent of the one or more AI agents, the user input, and executing, using the LLM agent, one or more query operations against the one or more external data sources using the normalized user input. In some embodiments, retrieving the external data may include collecting a plurality of candidate data items from the one or more external data sources as a function of the user input, filtering the plurality of candidate data items as a function of relevance conditions associated with at least one of the user input and the image data, and generating a synthesized representation of the filtered candidate data items for use in generating the one or more agent outputs. These may be implemented as described and with reference to FIGS. 1-9.

With continued reference to FIG. 10B, method 1000b contains a step 1065 of updating, using at least a processor, a display data structure, wherein updating the display data structure includes updating at least an activity window as a function of one or more agent outputs. In some embodiments, the display data structure may include at least a primary window configured to display the image data, and one or more interactive elements associated with the at least a primary window and the at least an activity window. In some embodiments, updating the display data structure may include updating the at least a primary window as a function of the user interaction with the one or more interactive elements, wherein the user interaction may include selecting the one or more interactive elements to modify a presentation state of the at least a primary window within the display data structure. In some embodiments, updating the at least an activity window may include identifying and extracting, using one or more image processing agents of the one or more AI agents, a region of interest from the image data as a function of the user input, and updating the at least an activity window to modify a presentation state of the at least an activity window as a function of the region of interest, wherein modifying the presentation state of the at least an activity window may include spatially aligning the derived content presented in the at least an activity window with a corresponding spatial location of the region of interest in the image data. These may be implemented as described and with reference to FIGS. 1-9.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

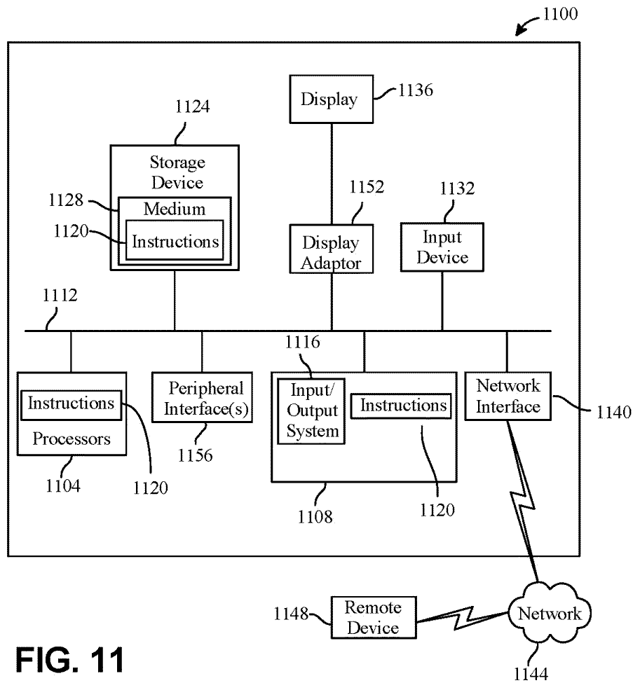

FIG. 11 shows a diagrammatic representation of one embodiment of a computing device in the exemplary form of a computer system 1100 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1100 includes a processor 1104 and a memory 1108 that communicate with each other, and with other components, via a bus 1112. Bus 1112 may include any of several types of bus structures including, but not limited to, a memory bus, a memory controller, a peripheral bus, a local bus, and any combinations thereof, using any of a variety of bus architectures.

Processor 1104 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1104 may be organized according to Von Neumann and/or Harvard architecture as a non-limiting example. Processor 1104 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC).

Memory 1108 may include various components (e.g., machine-readable media) including, but not limited to, a random-access memory component, a read only component, and any combinations thereof. In one example, a basic input/output system 1116 (BIOS), including basic routines that help to transfer information between elements within computer system 1100, such as during start-up, may be stored in memory 1108. Memory 1108 may also include (e.g., stored on one or more machine-readable media) instructions (e.g., software) 1120 embodying any one or more of the aspects and/or methodologies of the present disclosure. In another example, memory 1108 may further include any number of program modules including, but not limited to, an operating system, one or more application programs, other program modules, program data, and any combinations thereof.

Computer system 1100 may also include a storage device 1124. Examples of a storage device (e.g., storage device 1124) include, but are not limited to, a hard disk drive, a magnetic disk drive, an optical disc drive in combination with an optical medium, a solid-state memory device, and any combinations thereof. Storage device 1124 may be connected to bus 1112 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1124 (or one or more components thereof) may be removably interfaced with computer system 1100 (e.g., via an external port connector (not shown)). Particularly, storage device 1124 and an associated machine-readable medium 1128 may provide nonvolatile and/or volatile storage of machine-readable instructions, data structures, program modules, and/or other data for computer system 1100. In one example, software 1120 may reside, completely or partially, within machine-readable medium 1128. In another example, software 1120 may reside, completely or partially, within processor 1104.

Computer system 1100 may also include an input device 1132. In one example, a user of computer system 1100 may enter commands and/or other information into computer system 1100 via input device 1132. Examples of an input device 1132 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1132 may be interfaced to bus 1112 via any of a variety of interfaces (not shown) including, but not limited to, a serial interface, a parallel interface, a game port, a USB interface, a FIREWIRE interface, a direct interface to bus 1112, and any combinations thereof. Input device 1132 may include a touch screen interface that may be a part of or separate from display 1136, discussed further below. Input device 1132 may be utilized as a user selection device for selecting one or more graphical representations in a graphical interface as described above.

A user may also input commands and/or other information to computer system 1100 via storage device 1124 (e.g., a removable disk drive, a flash drive, etc.) and/or network interface device 1140. A network interface device, such as network interface device 1140, may be utilized for connecting computer system 1100 to one or more of a variety of networks, such as network 1144, and one or more remote devices 1148 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1144, may employ a wired and/or a wireless mode of communication. In general, any network topology may be used. Information (e.g., data, software 1120, etc.) may be communicated to and/or from computer system 1100 via network interface device 1140.

Computer system 1100 may further include a video display adapter 1152 for communicating a displayable image to a display device, such as display 1136. Examples of a display device include, but are not limited to, a liquid crystal display (LCD), a cathode ray tube (CRT), a plasma display, a light emitting diode (LED) display, and any combinations thereof. Display adapter 1152 and display 1136 may be utilized in combination with processor 1104 to provide graphical representations of aspects of the present disclosure. In addition to a display device, computer system 1100 may include one or more other peripheral output devices including, but not limited to, an audio speaker, a printer, and any combinations thereof. Such peripheral output devices may be connected to bus 1112 via a peripheral interface 1156. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A system for augmented visualization using activity windows, wherein the system comprises:
at least a processor; and
a memory communicatively connected to the at least a processor, wherein the memory contains instructions configuring the at least a processor to:
receive image data;
generate a display data structure comprising at least an activity window configured to display derived content associated with the image data;
instantiate, within the at least an activity window, one or more artificial intelligence (AI) agents;
receive, in response to user interaction with the display data structure, a user input associated with the image data;
execute the one or more AI agents, wherein executing the one or more AI agents comprises:
generating, using the one or more AI agents, one or more agent outputs as a function of the image data; and
update the display data structure, wherein updating the display data structure comprises updating the at least an activity window as a function of the one or more agent outputs.

2. The system of claim 1, wherein executing the one or more AI agents further comprises:
retrieving, using the one or more AI agents, external data from one or more external data sources as a function of the user input; and
generating, using the one or more AI agents, one or more agent outputs as a function of the external data and the image data.

3. The system of claim 1, wherein the display data structure comprises:
at least a primary window configured to display the image data; and
one or more interactive elements associated with the at least a primary window and the at least an activity window.

4. The system of claim 3, wherein updating the display data structure comprises updating the at least a primary window as a function of the user interaction with the one or more interactive elements, wherein the user interaction comprises selecting the one or more interactive elements to modify a presentation state of the at least a primary window within the display data structure.

5. The system of claim 1, wherein executing the one or more AI agents comprises generating, using an image processing agent of the one or more AI agents, one or more processing outputs of the one or more agent outputs as a function of the image data, wherein the one or more processing outputs comprises annotation data associated with the image data.

6. The system of claim 2, wherein executing the one or more AI agents comprises:
correlating, using a large language model (LLM) agent of the one or more AI agents, the external data, the one or more processing outputs and the image data; and
generating, using the LLM agent, one or more natural language outputs of the one or more agent outputs as a function of the correlations among the external data, the one or more processing outputs and the image data.

7. The system of claim 2, wherein executing the one or more AI agents comprises:
generating, using a deterministic agent of the one or more AI agents, one or more deterministic outputs of the one or more agent outputs as a function of the image data, the external data and the user input; and
generating, using a LLM agent of the one or more AI agents, one or more natural language outputs of the one or more agent outputs as a function of the one or more deterministic outputs.

8. The system of claim 2, wherein retrieving the external data comprises:
normalizing, using a LLM agent of the one or more AI agents, the user input; and
executing, using the LLM agent, one or more query operations against the one or more external data sources using the normalized user input.

9. The system of claim 2, wherein retrieving the external data comprises:
collecting a plurality of candidate data items from the one or more external data sources as a function of the user input;
filtering the plurality of candidate data items as a function of relevance conditions associated with at least one of the user input and the image data; and
generating a synthesized representation of the filtered candidate data items for use in generating the one or more agent outputs.

10. The system of claim 1, wherein updating the at least an activity window comprises:
identifying and extracting, using one or more image processing agents of the one or more AI agents, a region of interest from the image data as a function of the user input; and
updating the at least an activity window to modify a presentation state of the at least an activity window as a function of the region of interest, wherein modifying the presentation state of the at least an activity window comprises spatially aligning the derived content presented in the at least an activity window with a corresponding spatial location of the region of interest in the image data.

11. A method of augmented visualization using activity windows, wherein the method comprises:
receiving, using at least a processor, image data;
generating, using the at least a processor, a display data structure comprising at least an activity window configured to display derived content associated with the image data;
instantiating, using the at least a processor, one or more artificial intelligence (AI) agents within the at least an activity window;
receiving, using the at least a processor, a user input associated with the image data in response to user interaction with the display data structure;
executing, using the at least a processor, the one or more AI agents, wherein executing the one or more AI agents comprises:
generating, using the one or more AI agents, one or more agent outputs as a function of the image data; and
updating, using the at least a processor, the display data structure, wherein updating the display data structure comprises updating the at least an activity window as a function of the one or more agent outputs.

12. The method of claim 11, wherein executing the one or more AI agents further comprises:
retrieving, using the one or more AI agents, external data from one or more external data sources as a function of the user input; and
generating, using the one or more AI agents, one or more agent outputs as a function of the external data and the image data.

13. The method of claim 11, wherein the display data structure comprises:
at least a primary window configured to display the image data; and
one or more interactive elements associated with the at least a primary window and the at least an activity window.

14. The method of claim 13, wherein updating the display data structure comprises updating the at least a primary window as a function of the user interaction with the one or more interactive elements, wherein the user interaction comprises selecting the one or more interactive elements to modify a presentation state of the at least a primary window within the display data structure.

15. The method of claim 11, wherein executing the one or more AI agents comprises generating, using an image processing agent of the one or more AI agents, one or more processing outputs of the one or more agent outputs as a function of the image data, wherein the one or more processing outputs comprises annotation data associated with the image data.

16. The method of claim 12, wherein executing the one or more AI agents comprises:
correlating, using a large language model (LLM) agent of the one or more AI agents, the external data, the one or more processing outputs and the image data; and
generating, using the LLM agent, one or more natural language outputs of the one or more agent outputs as a function of the correlations among the external data, the one or more processing outputs and the image data.

17. The method of claim 12, wherein executing the one or more AI agents comprises:
generating, using a deterministic agent of the one or more AI agents, one or more deterministic outputs of the one or more agent outputs as a function of the image data, the external data and the user input; and
generating, using a LLM agent of the one or more AI agents, one or more natural language outputs of the one or more agent outputs as a function of the one or more deterministic outputs.

18. The method of claim 12, wherein retrieving the external data comprises:
normalizing, using a LLM agent of the one or more AI agents, the user input; and
executing, using the LLM agent, one or more query operations against the one or more external data sources using the normalized user input.

19. The method of claim 12, wherein retrieving the external data comprises:
collecting a plurality of candidate data items from the one or more external data sources as a function of the user input;
filtering the plurality of candidate data items as a function of relevance conditions associated with at least one of the user input and the image data; and
generating a synthesized representation of the filtered candidate data items for use in generating the one or more agent outputs.

20. The method of claim 11, wherein updating the at least an activity window comprises:
identifying and extracting, using one or more image processing agents of the one or more AI agents, a region of interest from the image data as a function of the user input; and
updating the at least an activity window to modify a presentation state of the at least an activity window as a function of the region of interest, wherein modifying the presentation state of the at least an activity window comprises spatially aligning the derived content presented in the at least an activity window with a corresponding spatial location of the region of interest in the image data.
